(19) United States
(12) Patent Application Publication
(10) Pub. No.: US 2022/0212078 A1
(43) Pub. Date: Jul. 7, 2022

(54) BALL RETURN DEVICE AND SYSTEM

(71) Applicant: BECCA MOROS SOCCER, LLC, Larchmont, NY (US)

(72) Inventor: Rebecca Moros, Larchmont, NY (US)

(21) Appl. No.: 17/701,644

(22) Filed: Mar. 22, 2022

Related U.S. Application Data
(63) Continuation of application No. 15/406,191, filed on Jan. 13, 2017, now abandoned.
(60) Provisional application No. 62/278,917, filed on Jan. 14, 2016.

(51) Int. Cl. A63B 69/00; G09B 19/00

(52) U.S. Cl. CPC A63B 69/0097; A63B 2102/16; G09B 19/0038; A63B 69/0053

(57) ABSTRACT

Ball return devices may include a body having a front surface configured to return a ball incident thereon and a back surface. The body may be configured to be positioned at an angle to, and coincident with, an underlying surface, the angle between the ground surface and the body being variable. The ball return devices may also include an attachment mechanism coupled to the body and adapted to attach the body to an external anchoring mechanism.

### RELATED APPLICATION

This application is a Continuation of U.S. patent application Ser. No. 15/406,191 filed Jan. 13, 2017, which is a non-provisional of, and claims priority to, U.S. Provisional Patent Application No. 62/278,917 entitled “Ball Return Device and System” filed Jan. 14, 2016, both of which are incorporated by reference, in their entirety, herein.

### BACKGROUND

One common way recreational and professional soccer players as well as athletes of other ball-related sports (e.g., ping pong, tennis, basketball) practice their ball skills is to project a ball toward a rebounder (e.g., wall or net) and, in some instances, the rebounding device returns the ball via, for example, bouncing back via the law of conservation of momentum. However, when the ball rebounds, or is bounced back, it often does so in an undesirable way (e.g., bouncing rather than smoothly returning to the practicing player, or rebounding at an undesirable angle) thereby making it difficult to practice ball skills, which can waste the player's time.

### SUMMARY

Ball return devices and systems are herein described. A ball return device may have a body and an attachment mechanism. The body may have a front surface configured to return a ball incident thereon and a back surface. The body may be configured to be positioned at an angle to, and coincident with, an underlying surface (e.g., a court or grass field) and the angle between the ground surface and the body may be variable. The angle may be set and maintained by the attachment mechanism. Variability of the angle may be facilitated by adjusting a configuration of attachment mechanism and/or a position or orientation of the body relative to the underlying surface.

The attachment mechanism may be coupled to the body and adapted to attach the body to an external anchoring mechanism such as a fence, a post, a garage door, or a wall. In one instance, the external anchoring mechanism is a chain-link fence and a portion of the attachment mechanism is configured to pass through one or more of the chain links of the chain-link fence. In another instance, the external anchoring mechanism is a post and a portion of the attachment mechanism is configured to wrap partially around the post. Exemplary attachment mechanisms are a combination of a strap and a ratchet.

In some embodiments, the ball return device may include first and second beams. The first beam may project a first distance from the back surface and extend across at least a portion of a length of the back surface. The second beam may project a second distance from the back surface and extend at least a portion of a length of the back surface. In most cases, the second beam will not touch or be overlapping with the first beam. A relative relationship between the first distance of the first beam and the second distance of the second beam may orient the front surface at an angle of less than 90° relative to the underlying surface when the first beam and the second beam are positioned against a vertical anchoring mechanism oriented at an angle of approximately 90° relative to the underlying surface. In some embodiments, a relative relationship between the first distance of the first beam and the second distance of the second beam may orient the front surface at an angle of greater than 90° relative to the underlying surface when the first beam and the second beam are positioned against a vertical anchoring mechanism oriented at an angle of approximately 90° relative to the underlying surface. At times, an exterior surface of the first beam furthest away from the front surface is oriented at an angle that is not parallel to the front surface.

In some embodiments, the ball return device has a first attachment mechanism positioned at a first end of the body and a second attachment mechanism positioned at a second end of the body.

In some embodiments, the ball return device may include a support device joining mechanism configured to join with an external support device, the external support device may be adapted to maintain an orientation of the body once the body is positioned thereon.

In at least some embodiments, the body may include one or more joining mechanisms configured to enable the ball return device to be joined with another ball return device. Exemplary joining mechanisms include a peg and corresponding hole arrangement, a strap, and a clamp.

### BRIEF DESCRIPTION OF THE DRAWINGS

The present invention is illustrated by way of example, and not limitation, in the figures of the accompanying drawings in which:

FIG. 1 shows a front plan view of an exemplary ball return device body, consistent with some embodiments of the present invention;

FIG. 2 provides a side plan view of an exemplary ball return device body, consistent with some embodiments of the present invention;

FIG. 3 shows a rear perspective view of an exemplary ball return device body, consistent with some embodiments of the present invention;

FIG. 4 shows a side view of an exemplary ball return device attachment system, consistent with some embodiments of the present invention;

FIG. 5A depicts a rear view of an exemplary ball return device body, consistent with some embodiments of the present invention;

FIG. 5B shows a front view of an exemplary ball return device body that is affixed to a post, consistent with some embodiments of the present invention;

FIG. 6 is a side view of an exemplary ball return system, consistent with some embodiments of the present invention;

FIG. 7 shows a ball impacting a front surface of an exemplary ball return device, consistent with some embodiments of the present invention;

FIG. 8A shows rear plan view of an exemplary ball return device body supported by two support blocks, consistent with some embodiments of the present invention;

FIG. 8B shows a side view of an exemplary ball return device system, consistent with some embodiments of the present invention;

FIG. 9A shows front plan view of an exemplary ball return device, consistent with some embodiments of the present invention;

FIG. 9B shows a side view of an exemplary ball return device, consistent with some embodiments of the present invention;

FIG. 10A provides a front view of an exemplary ball return device body, consistent with some embodiments of the present invention;

FIG. 10B provides a top view of an exemplary ball return device body, consistent with some embodiments of the present invention;

FIG. 10C provides a side view of an exemplary ball return device body, consistent with some embodiments of the present invention;

FIG. 10D provides a composite perspective view of an exemplary ball return device body, consistent with some embodiments of the present invention;

FIG. 10E provides an exploded perspective view of an exemplary ball return device body, consistent with some embodiments of the present invention;

FIG. 11A provides a front view of first piece of an exemplary ball return device body, consistent with some embodiments of the present invention;

FIG. 11B provides a top view of the first piece of an exemplary ball return device body, consistent with some embodiments of the present invention;

FIG. 11C provides a side view of first piece of an exemplary ball return device body, consistent with some embodiments of the present invention;

FIG. 12A provides a front view of second piece of an exemplary ball return device body, consistent with some embodiments of the present invention;

FIG. 12B provides a top view of the second piece of an exemplary ball return device body, consistent with some embodiments of the present invention;

FIG. 12C provides a side view of second piece of an exemplary ball return device body, consistent with some embodiments of the present invention;

FIG. 13A provides a front view of third piece of an exemplary ball return device body, consistent with some embodiments of the present invention;

FIG. 13B provides a top view of the third piece of an exemplary ball return device body, consistent with some embodiments of the present invention;

FIG. 13C provides a side view of third piece of an exemplary ball return device body, consistent with some embodiments of the present invention;

FIG. 14 illustrates an exploded view of an exemplary ball return device body, consistent with some embodiments of the present invention;

FIG. 15A provides front plan view of an exemplary ball return device body, consistent with some embodiments of the present invention;

FIG. 15B provides a top plan view of an exemplary ball return device body, consistent with some embodiments of the present invention;

FIG. 15C provides a side plan view of an exemplary ball return device body, consistent with some embodiments of the present invention;

FIG. 15D provides a side view of upper beam, consistent with some embodiments of the present invention;

FIG. 15E provides a side view of lower beam, consistent with some embodiments of the present invention;

FIG. 15F provides an exploded view of an exemplary ball return device body, consistent with some embodiments of the present invention;

FIG. 16A-19B provide illustrations of various support mechanisms, consistent with some embodiments of the present invention; and

FIGS. 20A-20C provide images of an exemplary ball return device body when attached to an external anchoring mechanism in the form of a chain-link fence, consistent with some embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

Disclosed herein is a ball return system and device. The ball return devices may include a ball return device body or surface and a stand or other support or attachment mechanism. As used herein “ball return device” may refer to a system that includes a ball return device body and an attachment mechanism or stand and/or just the ball return device body. In general, when a player directs a ball toward the disclosed ball return device, the ball will impact a front surface thereof and be directed back toward the player in a controlled manner that conserves momentum. For ease of discussion, the system/device will be referred to collectively herein as a ball return device and, at times, a ball return device body. Additionally, although the following discussion relates primarily to soccer and soccer balls, a person of skill in the art will understand that the ball return device disclosed herein may be easily adapted to enable games and/or practice of various other ball sports such as field hockey, street hockey, tennis, racket ball, squash, baseball, lacrosse, and/or basketball by, for example, altering the placement, orientation, and/or configuration of the ball return device. In some embodiments, the ball return device disclosed herein may be used for sports that do not employ a spherical ball such as hockey.

The ball return devices disclosed herein may be made from any appropriate material including wood, plastic, aluminum, stainless steel, vinyl, foam, and combinations thereof In many cases, the ball return devices disclosed herein are designed and manufactured so as to be portable (e.g., with a weight that can be less than 20 pounds) and may be compact for easy storage and transport. The ball return devices disclosed herein are also configured to be easy to move and/or reposition by, for example, a player or a coach. Additionally, the ability of a single person to easily carry a ball return device makes this a device that can be incorporated into routine training activities and even “warming up” prior to a game or while waiting on the sidelines during a game.

In various embodiments, the ball return devices disclosed herein may be manufactured from a material that absorbs varying portions of the momentum of a ball upon impact. For example, the ball return devices disclosed herein may be manufactured from foam when a relatively high degree of impact momentum absorption is desired (as may be the case when practicing in relatively small spaces, indoors, or for training purposes (e.g., with children)) and from a high density and rigid plastic when a relatively low degree of momentum absorption is desired (as may be the case when practicing in relatively large spaces, or when attaching the ball return device permanently to a support mechanism at a soccer facility, recreation center, or in the backyard, or for other training purposes (e.g., when an elite player is practicing responding to fast-moving incoming balls, the common term for which is practicing at “game speed”)). In some embodiments, the ball return devices disclosed herein may be manufactured so as to have a plurality of options for momentum absorption via, for example, a cover, attachment mechanism, or other device that may be affixed to and/or positioned on a surface of the ball return devices disclosed herein. For example, the ball return devices disclosed herein may be manufactured from a high density and rigid plastic and may have a momentum-absorbing cover (made from, for example, foam or fabric) that attaches to a front surface of ball return device.

When playing and practicing soccer, passing and receiving (trapping) the ball are absolutely fundamental to playing the game and many individuals practice these skills by repeatedly kicking a ball against a wall. This enables one to have many “touches” on the ball (as many as 20 or 30 per minute) in a short period of time, and to practice receiving, controlling, maneuvering (repositioning) and then passing (skilled kicking) the ball back to the wall from a variety of assumed positions. This form of practice necessitates proximity to a substantial and permanent wall constructed on a firm surface, (e.g., grass, concrete, clay, asphalt, wood, etc.) such as found on a handball, or racquetball, court or simply a reasonably smooth cement wall, usually constructed on a cement surface. Almost invariably such a wall is at a 90° angle with the ground surface and a ball impacting a wall at a 90° angle very often pops up and bounces in an irregular fashion rather than rolling smoothly like a soccer pass from a teammate when returning to the practicing player. This bouncing or other unpredictable ball returning behavior is accentuated by, for example, variations in the wall surface (e.g., bumps or gaps), by striking the ball more forcefully, and/or when the player moves further from the wall. This bouncing is undesired for many reasons. For example, it interferes with rapid repetitive patterns, one-touch passing, and by creating a more random ball return pattern it disconnects the quality of the players initial strike/pass from the quality of the returned ball, depriving the player of significant feedback. Ideally, a well-executed pass to a ball return device should give the practicing player a good, game-realistic, pass in the return. By angling the device at something less than 90° to the surface, the ball is returned smoothly with much less bouncing enabling practicing repetitive patterns and giving the practicing player immediate feedback regarding the quality of his or her strike on the ball. This bouncing is also undesired because, for example, the player doesn't know where the ball is going to go when rebounding from the wall and he or she must chase the ball when it rebounds off the wall in an unpredictable direction. This wastes valuable time, threatens training engagement, and makes it difficult for players to practice in relatively close proximity to one another and not interfere with one another's practice by unpredictable rebounds.

Additionally, a limitation of this particular practice technique (i.e., kicking a ball against a wall at a 90° angle to the ground) is that adequately firm and solid, right angle walls are almost always constructed as part of a playground (e.g., cement) court for sports such as squash, racquetball etc., and therefore a soccer player cannot practice this technique on a grass or artificial turf surface, which is where soccer is typically played. Therefore, the soccer player cannot practice this technique on the surface upon which the game is typically played and any feedback received from kicking a ball at a wall of this type is inaccurate because it does not account for how a ball's behavior would be modified were it kicked and/or rolling on a grass or turf surface. Should the soccer player wish to practice his or her skills on grass or turf, he or she must kick a soccer ball along the soccer pitch and then run after the ball. This causes inefficiencies in practice because the soccer player spends more time running after the soccer ball (especially when practicing kicks that travel a relatively long distance) than kicking, or touching, the ball and receiving feedback regarding the accuracy of his or her kicks and/or ball directing skills.

The present invention overcomes these problems by providing a ball return device that may be used on an indoor and/or outdoor soccer field or practice facility thereby enabling the soccer player to practice ball-handling skills on the turf/ground upon which soccer is often played.

In many cases, the ball return devices disclosed herein may be placed on (i.e., be coincident with) an underlying surface (e.g., the ground) however, this need not necessarily be the case depending on, for example, a use case and/or user preference. For example, when a player desires to practice with a ball as it travels in the air, as may be the case when playing catch or hitting a ball with a racket, the system/device may be positioned above the ground at a desired height. When a player desires to practice ground passing and/or kicking a soccer ball, the player may position a ball return device so as to be near and/or coincident with the ground.

The ball handling devices disclosed herein also provide a surface from which a kicked ball returns to a player in a controlled manner because it offers the ability to adjust the relative angle between a front surface of the ball return device and the underlying surface (e.g., ground) upon which the ball return device rests. For example, when the ball return device is placed on the ground such that it makes an angle of less than 90° (e.g., 45°-88°) with playing surface, copying the position of the locked ankle of a kicking teammate, the ball returns to the kicker in a smoother fashion like a pass from another player, unlike when the same ball is kicked against a wall where the relative angle between the wall and the underlying surface is 90°. In a preferred embodiment, the angle is between 75 and 88° with the underlying surface. This enables a player to practice ball-handling skills in a more efficient and meaningful way.

The ball return devices disclosed herein also return an impacting ball, such as a soccer ball, with a spin (e.g., a back spin) that mimics a ball spin of an incoming pass (a ball rebounding off of a wall will not have such a ball spin due to bouncing/skipping along the surface). In this way, a player may practice both kicking the ball at the ball return device and receiving incoming/rebounded balls that are similar to incoming balls as they would be received during game play. Thus, the player is able to practice handling incoming balls (rebounded by the ball return device) that are similar to incoming balls from another player on a soccer field thus making practice more meaningful and relevant to game play. This is particularly relevant for balls rebounding off the ball return device body at an upward angle relative to the ground (as may occur when the ball return device body is pointed upwards with an angle greater than 90° relative to the underlying surface).

Also, the ball return devices disclosed herein are configured to return balls to players at a realistic game speed that mimics a firm pass received from another player (provided that the incoming momentum of the ball is sufficient to do so).

In addition, as the angle between the ball return device and the underlying surface becomes smaller, the ball slows somewhat in its return to the practicing player. This may be desired when, for example, a player is practicing kicking a ball so that it goes a far distance but does not have the room to practice such kicking with the traditional dimensions such practice would require. For example, a soccer player using a ball return device disclosed herein would be able to practice making 60 yard kicks of a soccer ball (by kicking the ball relatively hard) and have that ball returned to the soccer player at a manageable rate of speed without being 60 yards away from the ball return device. In some instances, an angle between the front surface of a ball return device body and the ground may be adjusted to further accommodate such a practice session. This use of the ball return devices disclosed herein may also be helpful in the case of training young children who are just learning to control the ball/play soccer because a reduction in ball speed of a ball rebounding off of a ball return device makes it easier for the children to interact with the rebounding ball and limits a potential cause of injury (e.g., being struck by a quickly moving rebounding ball). This makes teaching children proper ball-handling techniques safer, easier, and more productive. Additionally, or alternatively, in an embodiment where the ball being directed toward the ball return device is relatively small, as may be the case with, for example, a field hockey or street hockey ball, the angle may be decreased to accommodate the smaller size of the ball.

In some circumstances, the ball return device may be positioned on an underlying surface so that it makes an angle of greater than 90° (e.g., 95°-165°) with the underlying surface. In a preferred embodiment, the angle may be between 142°-161° and, in some instances, may be around 155° or 160°. In these circumstances, the ball consistently returns to the kicker at an angle above the underlying surface (i.e., pops up or does not roll along the ground) and with a spin and trajectory more typical of an incoming high pass (long ball) from another player. This enables a player to practice ball-handling skills (e.g., heading, trapping, passing) with deliberate high incoming balls and provides an opportunity for a player to practice receiving a high incoming ball and either stop the ball (to dribble another way) or pass it (i.e., kick it back to a ball return device) in an efficient and meaningful way (game-realistic). In live play, practice or a game, with a player from the opposing team pressuring you to win the ball it can be very difficult for a player to learn the skill of receiving high balls out of the air. The demand of visually tracking the ball through the air above head height, while switching attention back and forth from the ball to the pressuring opponent is incredibly challenging for a sport that requires foot/eye coordination because often a player can never see both at the same time. The ball return device, when the pop-up angle is employed, allows a player to get tremendous repetition and authentic training of this kind of skill. The training opportunity of a player popping the ball up in the air themselves is limited by the unrealistic flight of the ball coming straight down on them and does not allow for receiving a ball from one direction to move in another and find a teammate to pass to, both of which are critical decision making skills for the sport of soccer. The ball return devices disclosed herein address all of these training limitations, allowing a player to master fundamental skills as well as more sophisticated skills involving coordinating vision, body positioning and quick decision-making (i.e., passing again).

The ball return devices disclosed herein also return an impacting ball, such as a soccer ball, with a spin that mimics a ball spin of an incoming pass. In this way, a player may practice both kicking the ball at the ball return device and receiving incoming/rebounded balls that are similar to incoming balls as they would be received during game play. Thus, the player is able to practice handling incoming balls (rebounded by the ball return device) that are similar to incoming balls from another player on a soccer field thus making practice more meaningful and relevant to game play, as may not be the case with other known netted rebounders.

In some instances, the ball return devices described herein may be configured to be affixed to an external anchoring mechanism such as a fence (e.g., chain link, slat, picketed) and/or a fence post. In some embodiments, the ball return devices described herein may be configured to attach to a mechanism (e.g., loop or hook) affixed to and/or imbedded in, for example, the ground, a fence, a garage door, door frame and/or a wall. Affixing the ball return devices disclosed herein to an external anchoring mechanism may improve their ability to return the momentum of an impacting ball without falling over or otherwise moving as may be the case with other known free-standing ball rebounders.

Attaching a ball return device to an external anchoring mechanism provides a number of advantages. First, when a ball return device is attached to a fence-like external anchoring mechanism, the fence provides a backstop for the ball return device effectively catching any balls kicked toward a ball return device that miss the ball return device. Otherwise, the ball would travel past the ball return device requiring the player to chase after it, thereby wasting valuable practice time and effort, and discouraging a player from challenging him or herself too much. Second, some of the ball return devices disclosed herein can transfer momentum to the external anchoring mechanism and, therefore, can withstand impacts of greater force than a self-supporting ball return device, such as a net that tends to have little structural integrity, are unstable, fall over, and lose tension over time. Third, because some of the ball return devices disclosed herein partially rely on an external structure for rigidity and maintenance of a desired orientation with respect to an underlying surface, these ball return devices do not require equipment and/or parts that enable it to stand on its own (i.e., be self-supporting). This reduces the materials needed to manufacture the ball return device thereby decreasing the overall weight and size of the ball return device, which makes the ball return devices easier to transport and store than known rebounding devices.

Attaching a ball return device to an external anchoring mechanism provides the further advantage of being a stable and unchanging set up that reliably returns balls in the same manner and, in some instances, a ball returned to a player may be of a higher quality (e.g., easier to work with and “game speed”) than an incoming ball. The ball may be of higher quality when, for example, an incoming ball is not rolling along the ground (i.e., is bouncing as it approaches the ball return device) it may be returned as a ball rolling smoothly along the ground. In essence, a player is passing with a better partner than he or she may be, and is therefore able to practice at a higher level and improve faster.

In most cases, the front surface of a ball return device will be a single surface of uniform texture (e.g., smooth or with small textural features as may occur with fabric or fiberglass). This offers a firm and even rebounding surface, which is superior to known ball return products. For example, ball catching or return devices that employ a net extended across a structure (e.g., a PVC pipe structure) tend to have little structural integrity and loose their ability to return impacting balls over time because the net loosens/stretches and absorbs more momentum with each impact. They are also unstable and prone to falling over when impacted with a ball or even, in some cases, when subjected to wind. This is because they are not anchored to anything and/or are not of sufficient weight. Also, the flexibility in the net causes the ball to be returned (when the ball is not caught in the net) in a random direction at a random speed. Therefore, these devices provide less valuable feedback to the player as to the quality and/or accuracy of their effort to hit or kick the ball. Additionally, known ball return devices do not provide the speed and/or directional return adjustability afforded by the invention disclosed herein. Furthermore, many commonly used net-employing rebounders require a player to be perfectly in front of the net (not passing from the side) and incoming balls to impact the center of a net or surface so that they may be returned to the player properly. Failure to be in the perfect position and/or to direct the ball toward the center results in balls that impact a lower quality surface or even the frame holding up the net/rebounder, and balls rebounding off of either of these surfaces typically move in an unpredictable/erratic manner, speed, and spin. Furthermore, if the player is standing to the side of a typical netted rebounder trying to make a diagonal pass (arguably the most common angle to pass in soccer) the ball may not rebound at all and the pattern of repetition completely lost. The ball return devices disclosed herein do not require a ball to impact only a certain location on the impact/front surface and do not require a player to stand in one fixed position (relative to the face of the ball return device). A ball impacting many positions (e.g., far left or far right) on the front surface of the ball return devices disclosed herein will be returned in the same manner as a ball impacting a center position of the front surface. This allows a practicing player to pass the ball into the ball return device from a position off to the side, the ball traveling at a angle (˜45°) into the board, the player continuing on the run to receive the ball in a similar position on the other side of the ball return device, i.e., a “give-and-go” or “one-two”, a common skill for using a teammate (a two player combination) to beat an opposing player.

In addition, the present invention is particularly well adapted for soccer practice because it enables a player to kick a ball along the ground toward the ball return device body and receive a rebounded ball that is rolling along the ground. In contrast, the preferred striking point for a soccer ball on a traditional netted rebounder (i.e., target) is, necessarily, above the ground because the inherent characteristics of the netted rebounder (e.g., a frame and a net, with a target in the center of the net due to the elasticity of the net). Such a positioning for the target is simply not beneficial for a soccer player, who aims to improve his or her ground passing (the pass or kick most commonly used in soccer). Furthermore, the feedback provided by such a netted rebounder is wrong for a soccer player as a soccer player needs to practice receiving balls passed along the ground, which due to the limitations inherent to the netted rebounder, are impossible for the netted rebounder to provide.

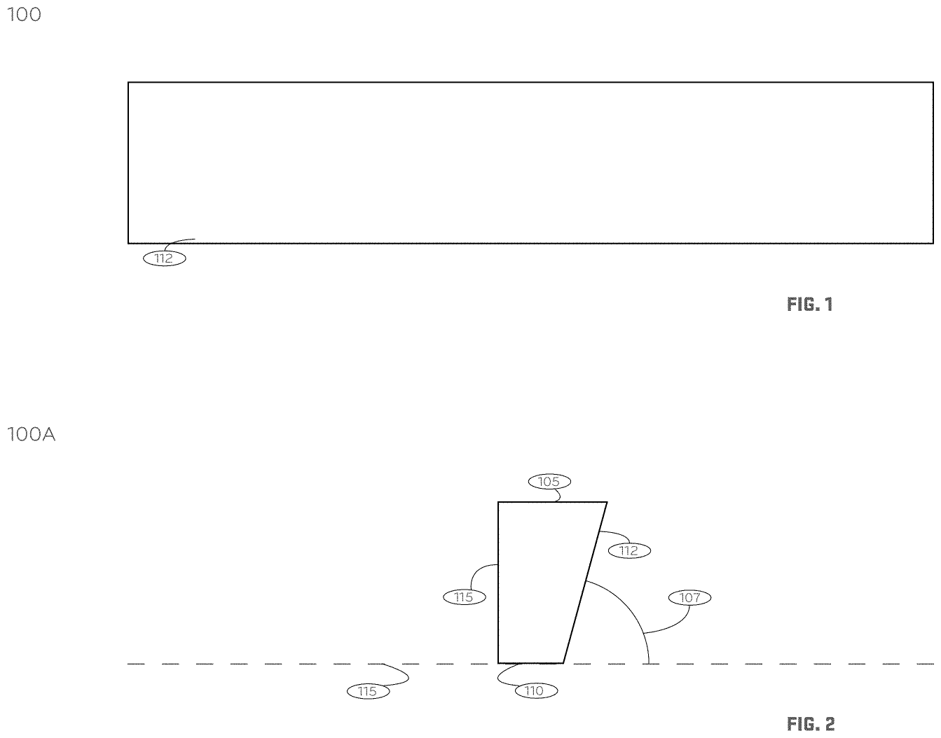

Turning now to the figures, FIG. 1 shows a front plan view of an exemplary ball return device body 100 with a front surface 112 that may be of any appropriate height and/or length however, in preferred embodiments, the length is a larger dimension than the height. In one example, ball return device body 100 has of a height of 1.5 feet and a length of 5 feet. In another example, ball return device body 100 has of a height of 1 foot and a length of 3 feet.

FIG. 2 provides a side plan view of ball return device body 100 with a front surface 112, a back surface 115, a top surface 105 and a bottom surface 110, which is coincident with an underlying surface 117. In some embodiments, surface 117 may be the ground. In other instances, surface 117 may be an imaginary line that is substantially in parallel with the ground. In some embodiments, ball return device body 100 may be manufactured so that the front surface 112 is not in parallel with a back surface 115. In this way, front surface 112 may not be perpendicular to underlying surface 117 upon which it rests, or is above (not shown), and may be positioned at an angle 107 relative to surface 117. The positioning of front surface 112 at angle 107 may be fixed and/or adjustable.

Angle 107 may be selected so as to provide a desired ball return rate of speed and/or direction. For example, in some embodiments, angle 107 may be in the range of approximately 45-88° so as to facilitate rapid return of the ball along the ground (or at an angle toward the ground when ball return device body 100 is positioned above the ground). As the magnitude of angle 107 is decreased, momentum absorption of ball return device body 100 will increase. Thus, as the magnitude of angle 107 decreases, the degree of momentum absorption increases. In some embodiments, angle 107 may be adjusted so as to accommodate different types of balls and/or balls of the same type but of differing sizes and/or inflation level as measured in, for example, pounds per square inch (PSI).

Although ball return device body 100 is shown in FIG. 2 as being oriented so bottom surface 110 is coincident with surface 117, this need not be the case as ball return device body 100 may be rotated 180° or otherwise repositioned so that the top surface 105 is coincident with surface 117. Ball return device body 100 may be used in this fashion to, for example, deflect an incoming ball in an upward direction as may desired when, for example, a player wants to practice trapping a ball that is falling from above head height after impacting ball return device body 100.

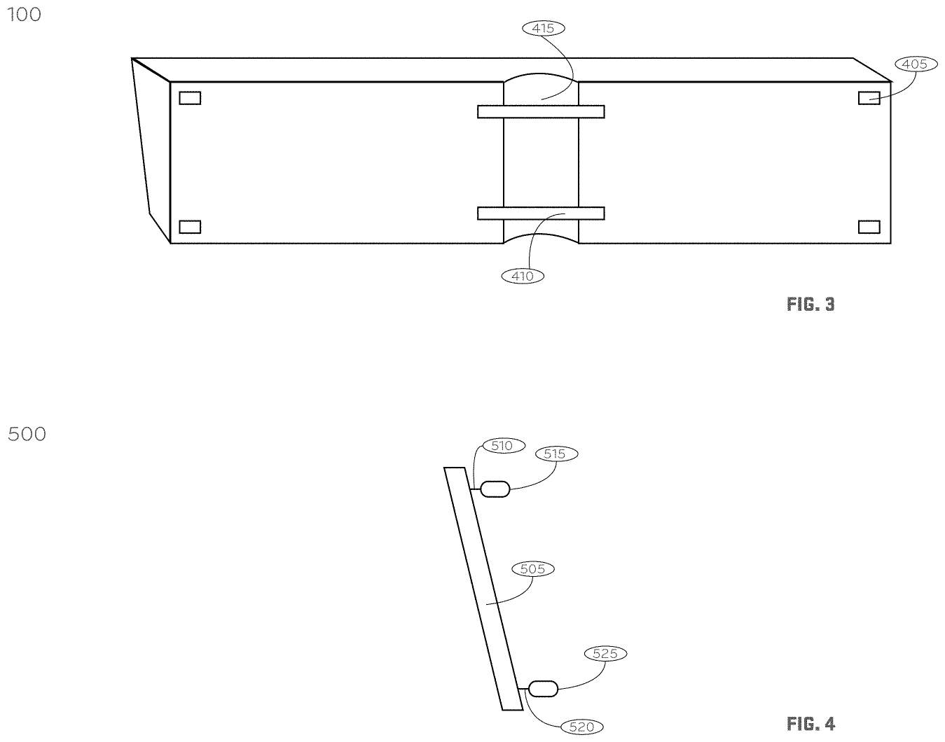

FIG. 3 shows a rear perspective view of an exemplary ball return device body 100 with a curvilinear depression 415 designed to accommodate, for example, insertion of a fence post or other vertically oriented anchoring mechanism therein. Curvilinear depression 415 may have one or more attachment mechanisms 410 that extend across curvilinear depression 415 and are adapted to assist in affixing ball return device body 100 to an anchoring mechanism. The exemplary ball return device body 100 of FIG. 3 may also include a plurality of openings or other attachment mechanisms 405 and a plurality of fence-post attachment mechanisms that may be, for example, straps, clamps, rigid rings, etc. designed to go around the fence post/anchor so as to secure the exemplary ball return device body 100 thereto.

FIG. 4 shows a side view of an exemplary ball return device attachment system 500. Ball return device attachment system 500 includes vertical component 505 and an upper attachment mechanism 515 that is connected to the vertical component 505 via a connector 510. The vertical component 505 is also attached to a lower attachment mechanism 525 via a connector 520.

Exemplary ball return device attachment system 500 may be designed to affix to the rear of a ball return device body 100 and attachment mechanisms 515 and/or 525 may be designed to fit around, or otherwise attach to, an anchoring mechanism for the ball return device body 100 so as to provide support and stability for the ball return device body 100. In some embodiments, two or more exemplary ball return device attachment systems 500 may be affixed to the rear of a ball return device body 100.

In some embodiments, connector 510 and/or 520 may be adjustable so as to vary an angle between vertical component 505 and, for example, the ground. In other embodiments, connector 510 and/or 520 may set attachment mechanisms 515 and/or 525 at a fixed distance from vertical component 505 thereby making an angle between vertical component 505 and the ground constant.

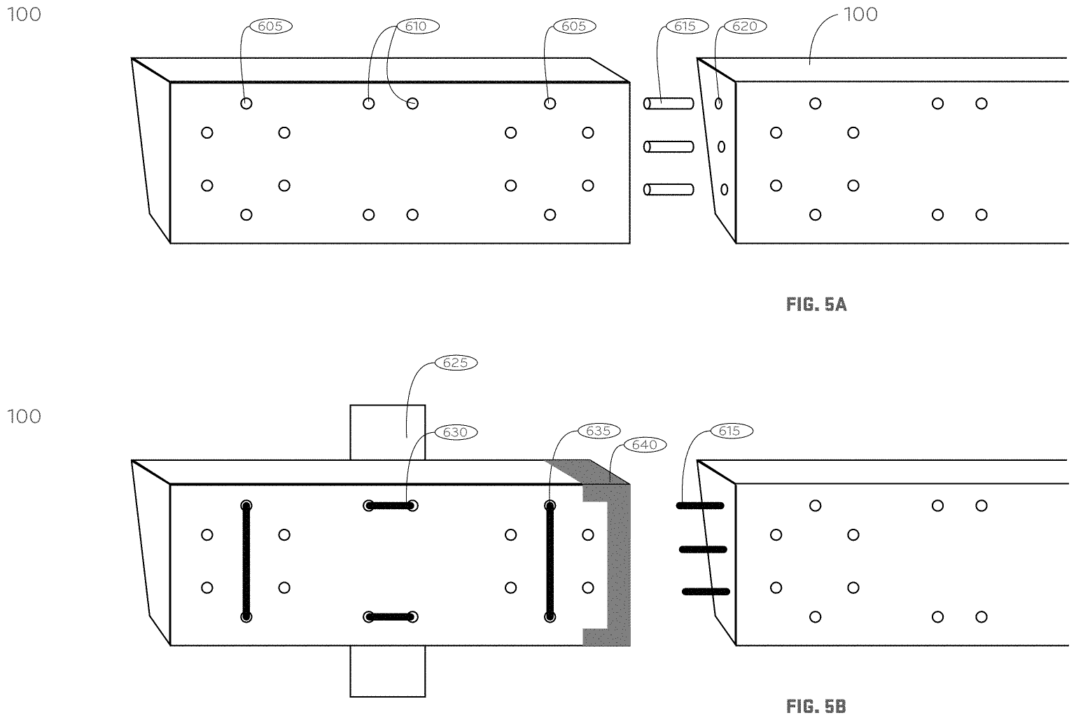

FIG. 5A depicts a rear view of an exemplary ball return device body 100. Ball return device body 100 has a plurality of holes 605 or other openings through which a fastening mechanism may be passed so as to affix ball return device body 100 to an anchoring mechanism (e.g., fence, post, or anchor). Holes 605 may be of any appropriate shape (e.g., circular, square, oval, etc.) and may be positioned on ball return device body 100 in any appropriate configuration (e.g., circular, hexagonal, square, etc.). In some embodiments, ball return device body 100 may be affixed to the anchoring mechanism by using a rope or strap fed through a hook or loop affixed to, for example, a surface of ball return device body 100.

In some cases, ball return device body 100 may include a plurality of center attachment mechanisms 610 that are configured to enable attachment of ball return device body 100 to, for example, a center post or anchor. In some instances, center attachment mechanisms 610 may operate to facilitate attachment of ball return device body 100 to a fence post or center beam and holes 605 may operate to attach the sides of ball return device body 100 to the fencing itself as may be the case with chain-link fencing.

In some embodiments ball return device body 100 may be configured to couple to another ball return device body 100 via, for example, side-by-side placement of the two ball return device bodies 100 that are coupled together via a joining mechanism. An exemplary joining mechanism is shown in FIG. 5A as a peg 615 and corresponding hole 620 arrangement. In the embodiment of FIG. 5A, the pegs 615 are separate pieces but this is not necessarily the case. For example, a joining mechanism may be a piece of ball return device body 100 that folds out, or otherwise extends, to fit into a corresponding depression in an adjacent ball return device body 100. Additionally, or alternatively, two or more ball return device bodies 100 may be coincidently placed and/or affixed together via, for example, straps, hooks, or other devices.

FIG. 5B shows a front view of ball return device body 100 that is affixed to a post 625 via two attachment mechanisms 630 fed through four corresponding attachment mechanisms 610. Exemplary attachment mechanisms 630 include straps or clamps that may be fed through attachment mechanisms 610 so as to be accessed on the back side of ball return device body 100, wrapped around post 625, and then affixed/tied together via, for example, a knot and/or clamp. The ball return device body 100 of FIG. 5B also shows fencing attachment mechanisms 635 which are each fed through holes 605.

FIG. 5B also shows an optional joining mechanism 640 that may be used to facilitate the joining of two ball return device bodies 100 together. Joining mechanism 640 may be designed to fit on one, or both, ball return device bodies 100 that are being joined together. Joining mechanism 640 may attach to one, or both, ball return devices via, for example, a groove, pegs 615, clips, etc.

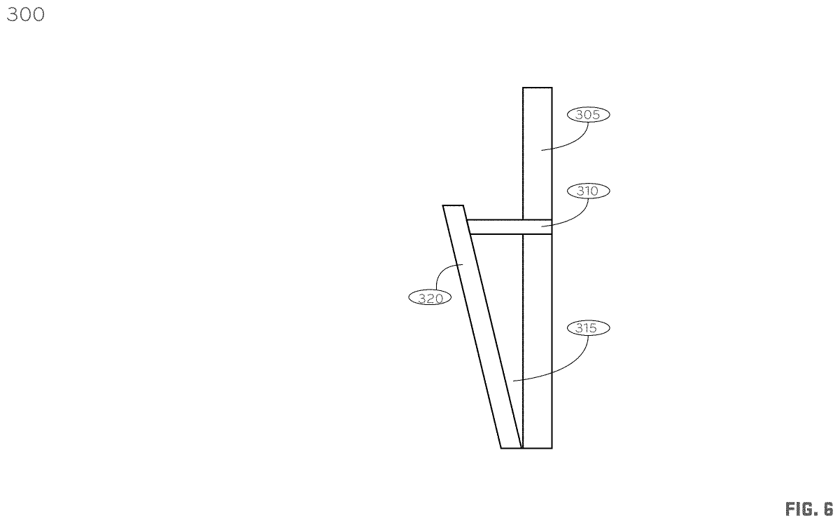

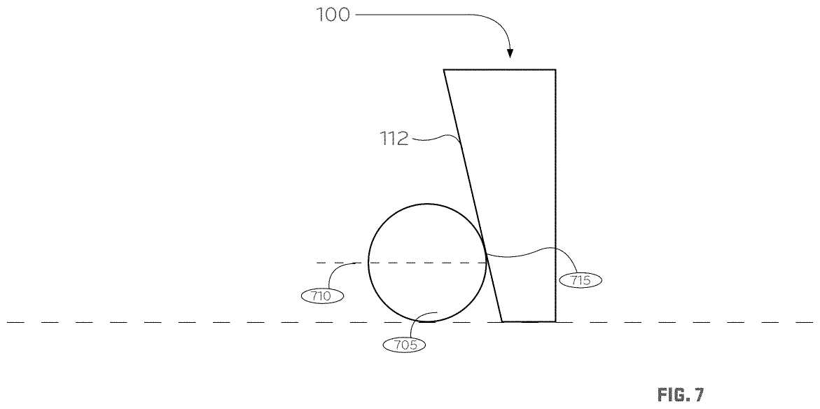

Joining mechanism 640 may be configured to occupy a region (e.g., top and/or bottom) of a front surface of one, or both, ball return device bodies 100 that does not typically come into contact with a ball that impacts the ball return devices. Although the joining mechanism 640 shown in FIG. 6B only attaches to one of the ball return device bodies 100, this is not necessarily the case. For example, a single joining mechanism 640 may couple the two ball return device bodies 100 together or each ball return device bodies 100 may have it's own joining mechanism 640.

FIG. 6 is a side view of another exemplary ball return system 300 that includes a front surface 320 affixed to an anchor 305 via an attachment mechanism 310. Exemplary anchors 305 include, but are not limited to, a fence post, a fence (e.g., chain link or picket), and a wall. Exemplary attachment mechanisms 310 include, but are not limited to, straps, ropes, hooks, loops, etc. Front surface 320 may be made from any appropriate material including, but not limited to wood and plastic. Front surface 320 may share one or more characteristics with ball return device body 100.

Ball return system 300 may be configured so that an angle 315 between board 320 and anchor 305 varies by, for example, adjustment of attachment mechanism 310 and/or placement of front surface 320. Also, while only one attachment mechanism 310 is shown in FIG. 3, a person of ordinary skill will recognize that any number of attachment mechanisms 310 may be used.

FIG. 7 shows a ball 705 impacting a front surface of an exemplary ball return device body 100 at an impact point 715 above the midline, or horizontal center, 710 of a ball 705. Impacting the ball 705 above midline 710 causes the ball 705 to be directed downward, or toward the ground and the ball will be returned to the player along the ground. This may be beneficial when practicing kicking, for example, a soccer ball toward ball return device body 100 as it may act to control the return of the ball toward the player (or kicker) so that the returning ball rolls along the ground as opposed to popping up into the air as would be the case were the ball kicked up against a wall that was perpendicular to the ground or a surface parallel thereto.

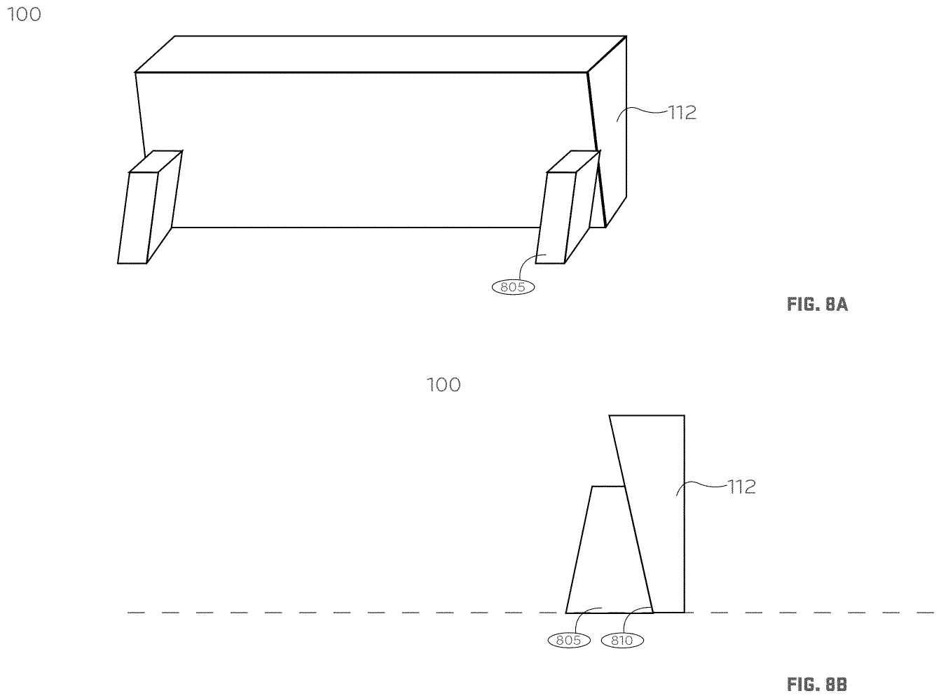

FIG. 8A shows rear plan view of an exemplary ball return device body 100 supported by two support blocks 805. The two support blocks 805 are positioned at opposing ends of the ball return device body 100 when the ball return device body 100 is oriented with the length (longest portion) of the board being substantially parallel with the ground or an underlying surface and positioned at an angle of approximately 90° relative to the ground/underlying surface. Support blocks 805 may be permanently and/or removably affixed to ball return device body 100.

FIG. 8B shows a side view of the exemplary ball return device body 100 of FIG. 8A. As can be seen in FIG. 8B, support block 805 has a trapezoidal-like shape with a bottom edge being longer than a top edge and first and second side edges that extend, at an angle, from one corner of the lower edge to a corresponding corner of the top edge, respectively. FIG. 8B shows how the support block 805 and ball return device body 100 fit together so that a first edge of support block 805 is coincident with a rear, or back, surface of ball return device body 100.

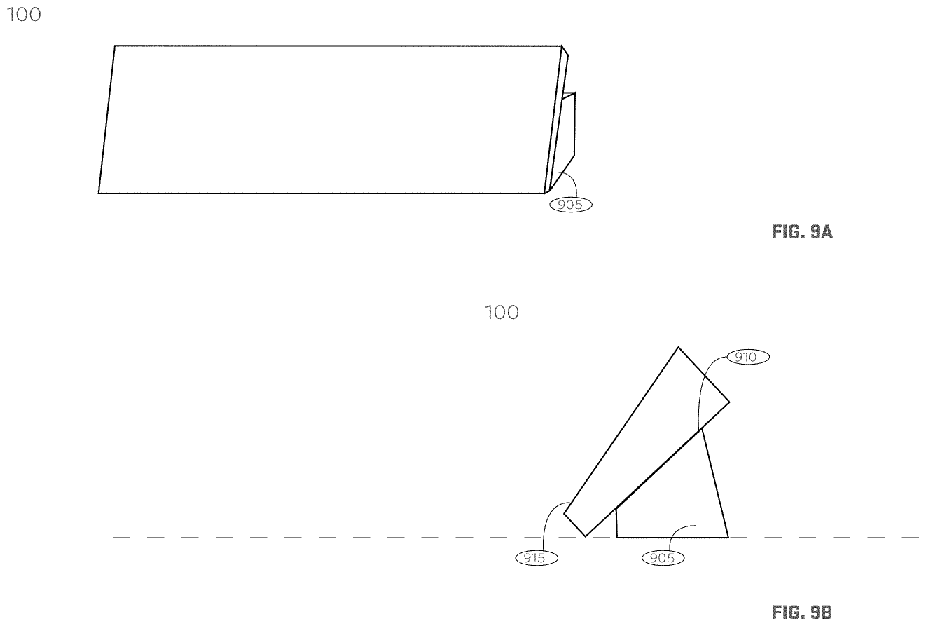

FIG. 9A shows front plan view of an exemplary ball return device body 100 supported by two support blocks 905 (only one of which is shown). The two support blocks 905 are positioned at opposing ends of the ball return device body 100 when the ball return device body 100 is oriented with the length (longest portion) of the board being substantially parallel with the ground or an underlying surface and positioned at an angle of greater than approximately 90° relative to the ground/underlying surface.

FIG. 9B shows a side view of the exemplary ball return device body 100 of FIG. 9A. As can be seen in FIG. 9B, support block 905 has a polygon shape with four sides. A bottom edge is adapted to rest on the ground or an underlying surface and a first side edge extends from the bottom edge to meet a top edge which is positioned at an angle relative to the first side edge so as to correspond with a back side of ball return device body 100 when positioned thereon. A second side edge extends between the top edge and the bottom edge to complete the structure of support block 905.

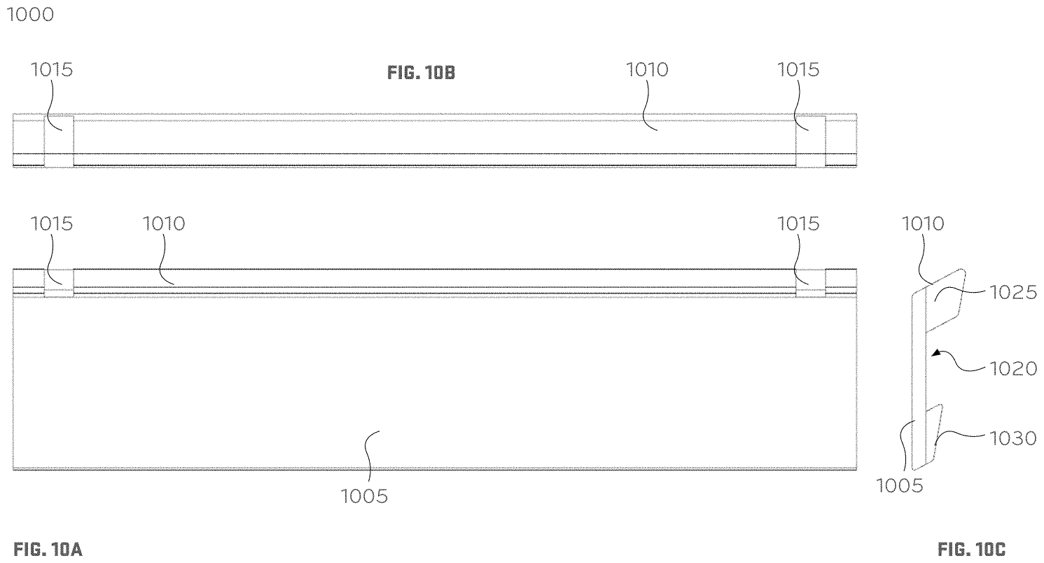

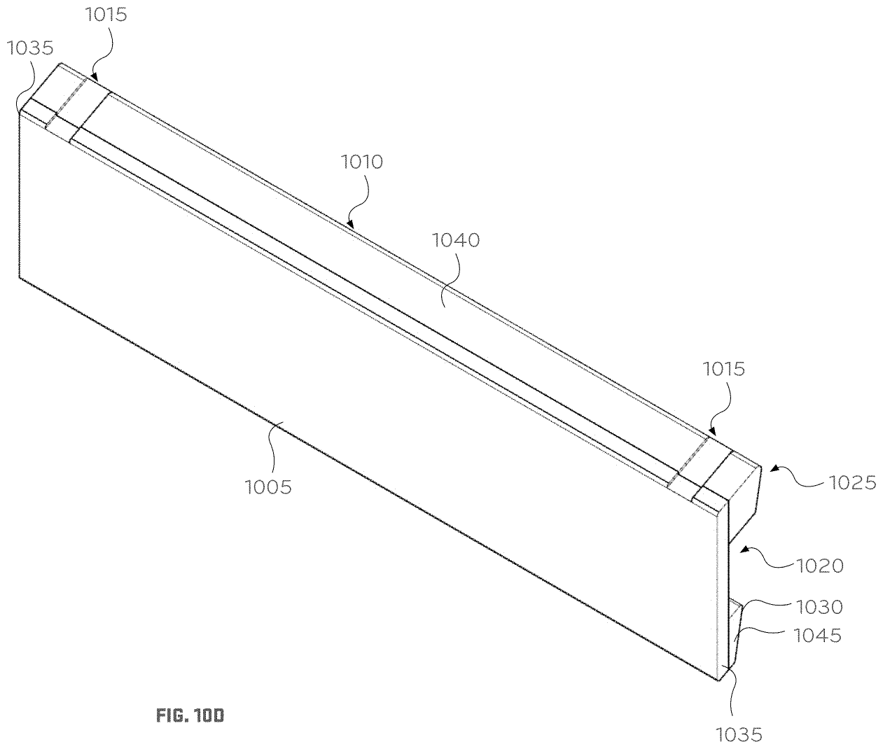

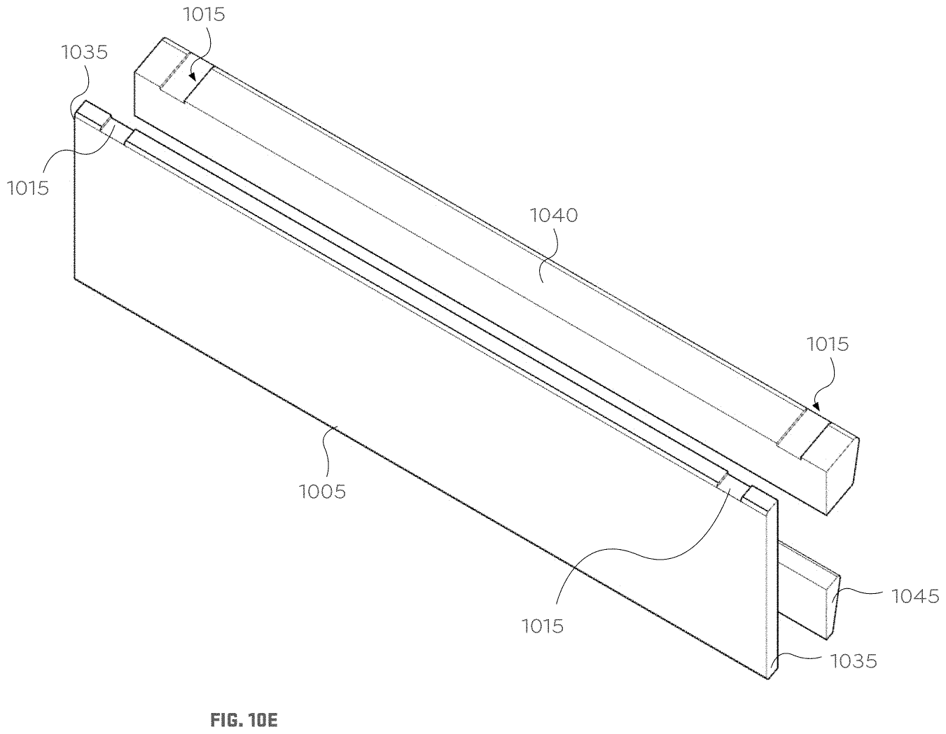

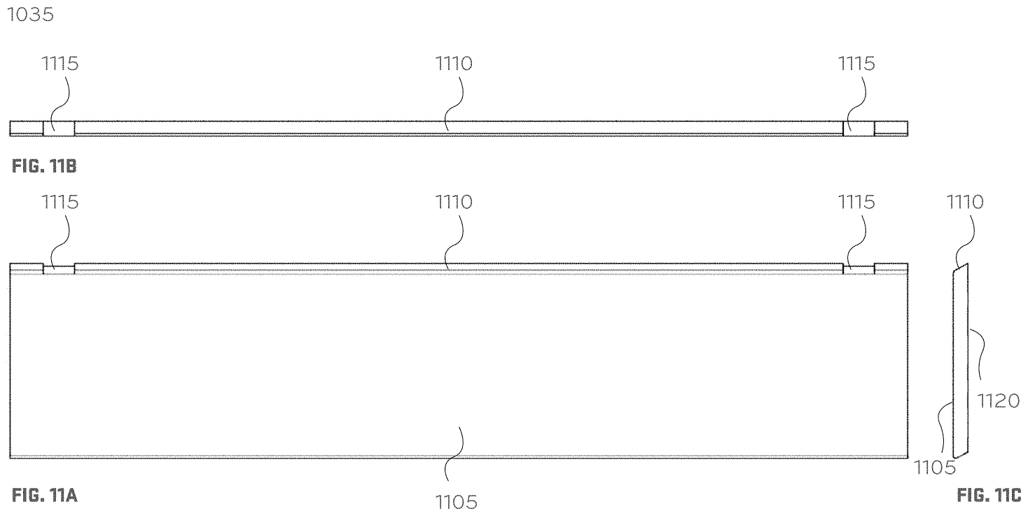

FIGS. 10A-10E provide another exemplary ball return device body 1000 shown from various angles. More specifically, FIG. 10A provides a front view of ball return device body 1000, FIG. 10B provides a top view of ball return device body 1000, FIG. 10C provides a side view of ball return device body 1000, FIG. 10D provides a composite perspective view of ball return device body 1000, and FIG. 10E provides an exploded perspective view of ball return device body 1000.

Ball return device body 1000 includes a front surface 1005, a top surface 1010, and a notch 1015 into which, for example, an attachment mechanism may be positioned. It should be noted that although surface 1010 is referred to herein as a “top surface” ball return device 1000 need not necessarily be oriented so that surface 1010 is on top (i.e., not in contact with an underlying surface). Indeed, there are circumstances when ball return device body 1000 may be oriented so that surface 1010 may be coincident with an underlying surface and may not, therefore, be a “top” surface.

Exemplary dimensions for the front surface 1005 include a length of 24-60 inches and a height of 5-24 inches. Exemplary dimensions for the top surface 1010 include a length of 24-60 inches and may be consistent with a length of the front surface 1001) and a width of 1-6 inches. Exemplary dimensions for the notch 1015 include a width of 0.5-4 inches and a length of 1-6 inches. In some instances, the top surface 1010 may be oriented at an angle of greater than 90° relative to the front surface 1005.

As shown in FIG. 10C, a back surface of ball return device body 1000 may include an upper beam 1025 and a lower beam 1030 with a cutaway or carve out 1020 therebetween. As shown in FIG. 10C, an upper edge of upper beam 1025 is coincident with top surface 1010 and a lower edge of lower beam 1030 is coincident with a lower edge of front surface 1005 but, this need not necessarily be the case as upper beam 1025 and/or lower beam 1030 may be offset from the top surface 1010 and/or lower edge, respectively.

Upper beam 1025 and lower beam 1030 may run the entire length of the back surface of ball return device body 1000 and/or a portion or portions thereof. In many instances, upper beam 1025 and lower beam 1030 are parallel to one another but this need not be the case. In many instances, upper beam 1025 may be larger, and extend further away from front surface 1005, than lower beam 1030. In this way, upper beam 1025 supports the positioning of front surface 1005 at an angle of less than 90° relative to the ground, or an underlying surface, upon which ball return device body 1000 rests. Upper beam 1025 also acts to maintain the position of front surface 1005 at the angle of less than 90° relative to the ground when ball return device 1000 is positioned against a vertically oriented surface when front surface is impacted with another object (e.g., a ball).

Exemplary widths for upper beam 1025 include, but are not limited to, 1-6 inches and heights of 2-7 inches. In some embodiments, a top edge of upper beam 1025 may be positioned at an angle of greater than 90° relative to the front surface 1005 (e.g., 110°-150°). Often times a lower edge of upper beam 1025 may be parallel to the top edge of upper beam 1025 but this need not necessarily be the case. A side edge of upper beam 1025 may be positioned at an angle of, for example, 5-40° relative to the front surface 1005.

Exemplary widths for lower beam 1030 include, but are not limited to, 1-6 inches at the widest point and may taper to a smaller width toward the bottom edge of front surface 1005. Exemplary heights for lower beam 1030 include, but are not limited to, heights of 2-7 inches. In some embodiments, a top edge of lower beam 1030 may be positioned at an angle of less than 90° relative to the front surface 1005 (e.g., −10° to −50° (i.e., 270°-230°)) (not shown). Often times a lower edge and/or an upper edge of lower beam 1030 may be parallel to the top edge of lower beam 1030 and/or a lower or upper edge of upper beam 1025 but this may not necessarily be the case. A side edge of lower beam 1030 may be positioned at an angle of, for example, 5-40° relative to the front surface 1005. In most instances, the angle at which the side edge of lower beam 1030 is positioned relative to front surface 1005 may be the same as, or substantially similar to, the angle at which the side edge of upper beam 1025 is positioned relative to front surface 1005.

The lower edge of upper beam 1025 and the upper edge of lower beam 1030 may define the upper and lower edges of cutaway 1020. A width of ball return device body 1000 between front surface 1005 and the edge of cutaway may be, for example, 0.25-3 inches. In some embodiments, cutaway 1030 may include one or more structural supports (not shown) that may act to structurally support ball return device body 1000. One purpose of cutaway 1020 is to decrease the overall weight of ball return device body 1000 by removing unnecessary material therefrom. It may also serve as a location for the application/attachment of one or more support mechanisms.

FIG. 10D provides a composite perspective view of ball return device body 1000 that shows a first piece 1035, a second piece 1040, and a third piece 1045 assembled to form ball return device body 1000. FIG. 10E provides a exploded perspective view of ball return device body 1000 that shows first piece 1035, a second piece 1040, and a third piece 1045 arranged for assembly into ball return device body 1000. FIGS. 11A-13C provide views of each of first piece 1035, a second piece 1040 and a third piece 1045.

More specifically, FIG. 11A provides a front view of first piece 1035, FIG. 11B provides a top view of first piece 1035, and FIG. 11C provides a side view of first piece 1035. A front surface 1105 of first piece 1035 is roughly the same shape and size as front surface 1005. When a ball rebound device 1000 is fully assembled, a covering (e.g., paint, fabric, vinyl, etc.) may be applied to front surface 1105 to generate front surface 1005. As may be seen in FIG. 11B, first piece 1035 also has a top surface 1110 and a portion of notch 1115, which is a portion of notch 1015. FIG. 11C shows a back surface 1120 of first piece 1035, which may be a first portion of cutaway 1020.

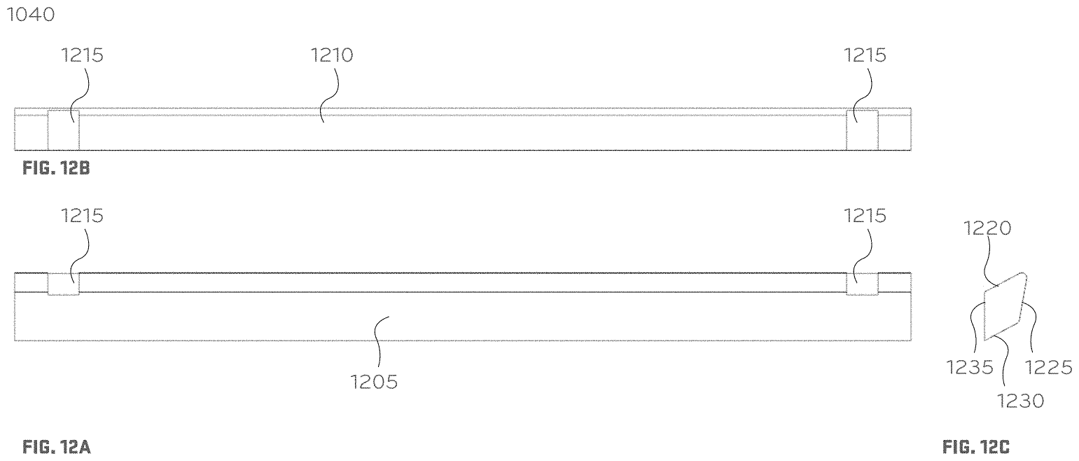

FIG. 12A provides a front view of second piece 1040, FIG. 12B provides a top view of second piece 1040, and FIG. 12C provides a side view of second piece 1040. A front surface 1205 of second piece 1040 is roughly the same length as front surface 1005 and, when a ball rebound device 1000 is assembled, second piece 1040 may be affixed to first piece 1035 to build a portion upper extension 1025. As may be seen in FIG. 12B, second piece 1040 also has a top surface 1210 and a notch 1215, which is a portion of notch 1015. As shown in FIG. 12C, second piece 1040 has four edges: an inside edge 1235, an outside edge 1225, a top edge 1220, and a bottom edge 1230, of which a top edge 1220 and a bottom edge 1230 may be parallel with one another. Assuming second piece 1040 is oriented vertically (as shown in FIG. 12C), then outside edge 1225 may be positioned at an angle of approximately 30-80° relative to a bottom of inside edge 1235, top edge 1220 may be positioned at an angle of approximately 5-25° relative to a top of inside edge 1212, and bottom edge 1230 may be positioned at an angle of approximately 10° to 65° relative to inside edge 1215.

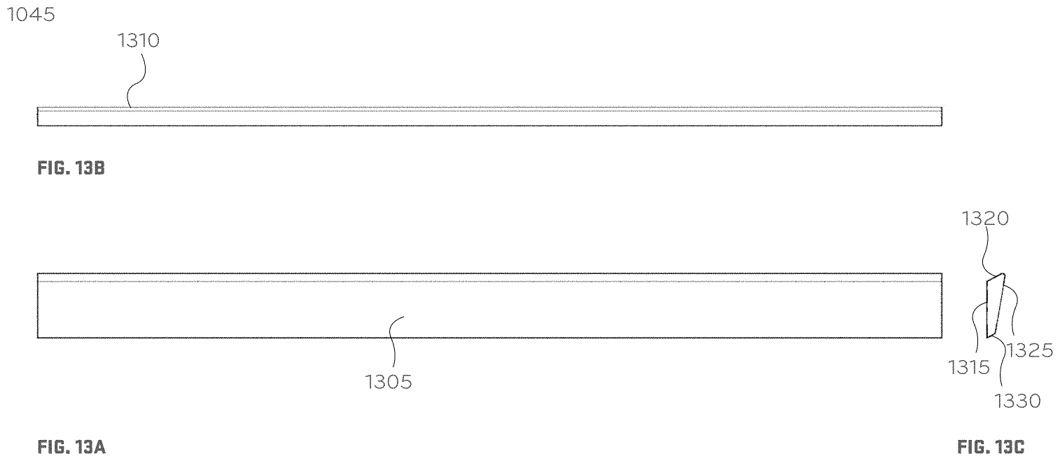

FIG. 13A provides a front view of third piece 1045, FIG. 13B provides a top view of third piece 1045, and FIG. 13C provides a side view of third piece 1045. A front surface 1305 of third piece 1045 is roughly the same length as front surface 1005 and, when a ball rebound device 1000 is assembled, third piece 1045 may be affixed to first piece 1035 to build a portion of lower extension 1030. As shown in FIG. 13C, third piece 1045 has four edges; an inside edge 1315, an outside edge 1325, a top edge 1320, and a bottom edge 1330, none of which are parallel with one another. Assuming third piece 1045 is oriented vertically (as shown in FIG. 13C), then outside edge 1325 may be positioned at an angle of approximately 5-25° relative to inside edge 1315, top edge 1320 may be positioned at an angle of approximately −25° to −65° (i.e., 335° to 295°) relative to inside edge 1315, and bottom edge 1330 may be positioned at an angle of approximately 25° to 65° relative to inside edge 1315.

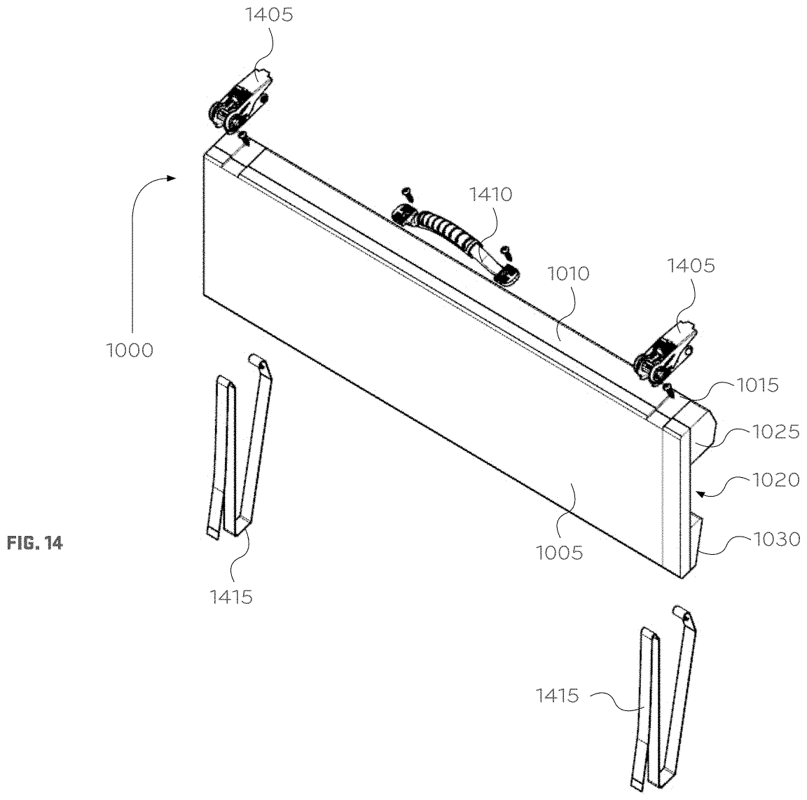

FIG. 14 illustrates an exploded view of ball return device body 1000 along with two ratchets 1405, a handle 1410, and two straps 1415 with one ratchet 1405 being positioned so as to enter and be affixed to each notch 1015 and handle 1410 being positioned at a center position along the top surface of ball return device body 1000. Each of ratchets 1405 are intended to be used with a separate strap 1415 that may be used to affix ball return device body 1000 to, for example, a fence, pole, or wall. It will be understood that the number of ratchets 1405 provided by FIG. 14 is exemplary and any number of ratchets 1405 (or other attachments mechanisms may be used). Handle 1410 may be any handle or device to aid in the gripping and/or carrying of ball return device body 1000 affixed to, or embedded within ball return device body 1000.

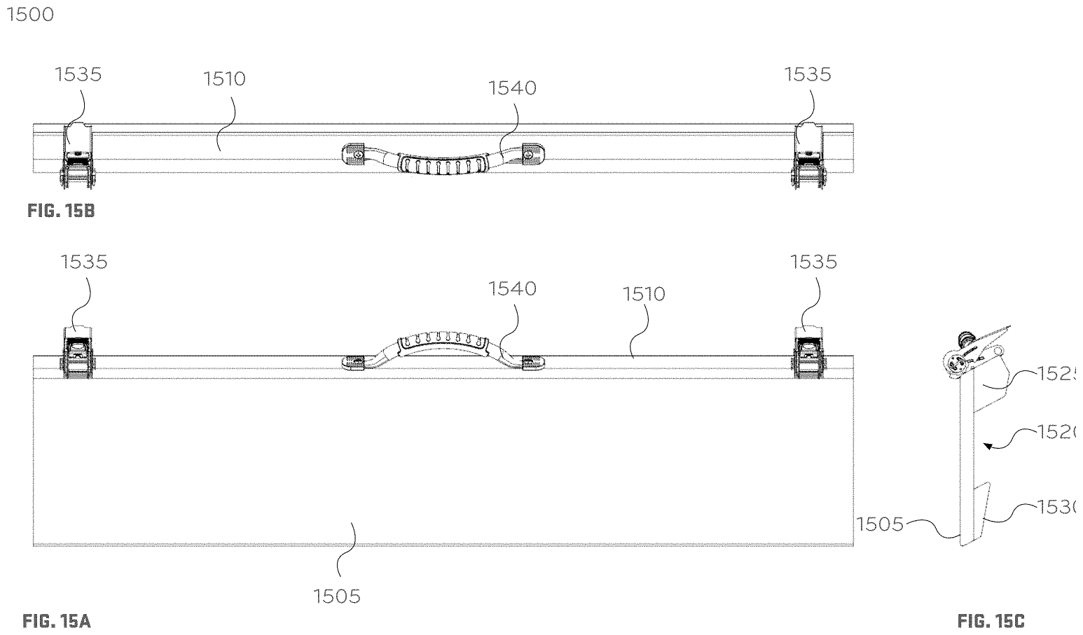

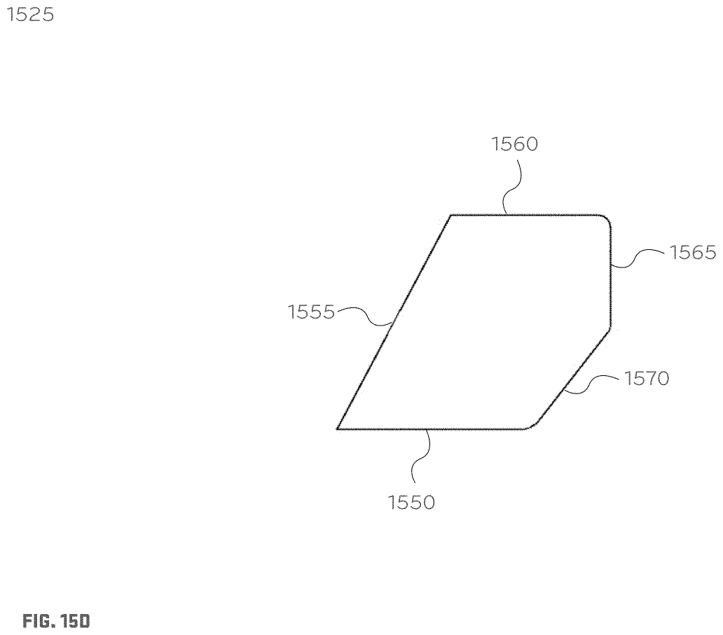

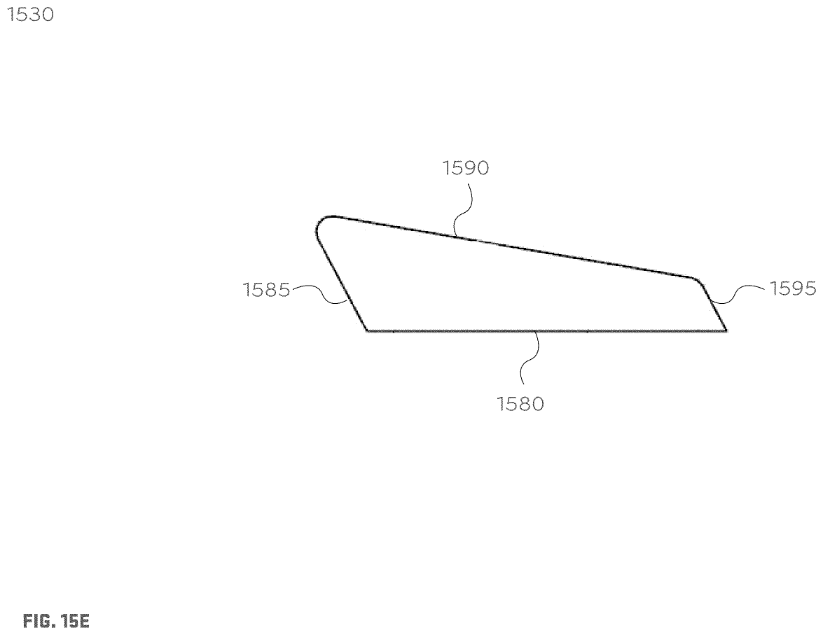

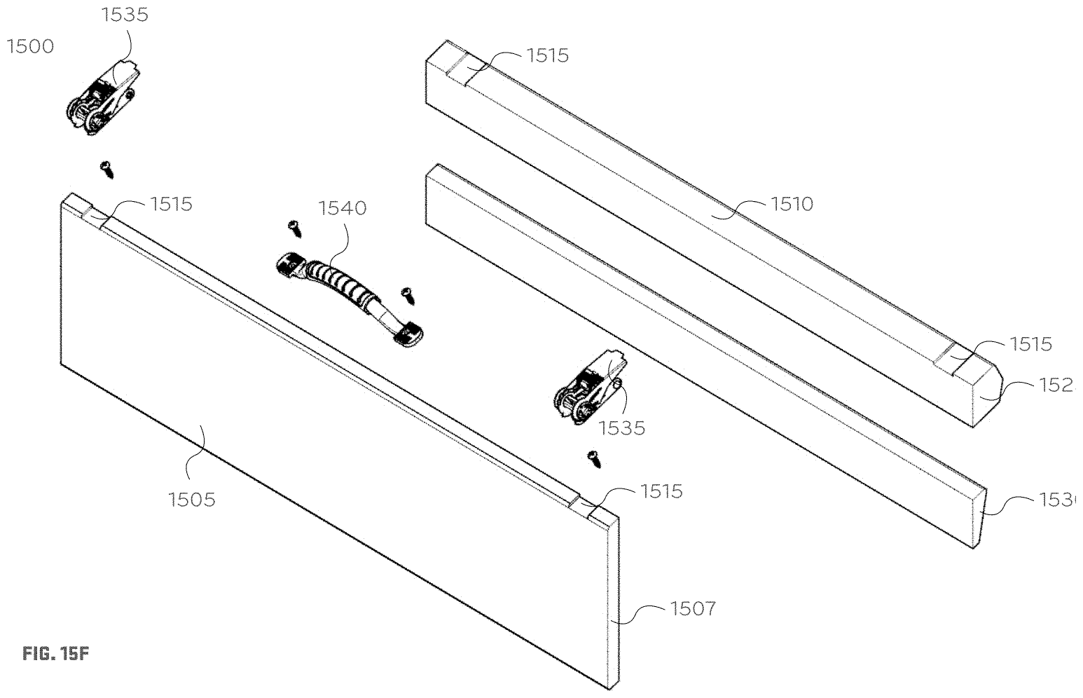

FIGS. 15A-15F provide exemplary views of an alternate exemplary ball return device body 1500. Ball return device body 1500 bears many similarities with ball return device body 1000 with the exception of the size and shape of the extensions on the back surface the ball return device. More specifically, FIG. 15A provides front plan view of ball return device body 1500, FIG. 15B provides a top plan view of ball return device body 1500, FIG. 15C provides a side plan view of ball return device body 1500, FIG. 15D provides a side view of upper beam 1525, FIG. 15E provides a side view of lower beam 1530, and FIG. 15F provides an exploded view of ball return device body 1500.

Ball return device body 1500 includes a front surface 1505, a top surface 1510, two ratchets 1535, and handle 1540. It should be noted that although surface 1510 is referred to herein as a “top surface” ball return device 1500 need not necessarily be oriented so that surface 1510 is on top (i.e., not in contact with an underlying surface). Indeed, there are circumstances when ball return device body 1500 may be oriented so that surface 1510 may be coincident with an underlying surface and may not, therefore, be a “top” surface.

Exemplary dimensions for the front surface 1505 include a length of 24-60 inches and a height of 5-24 inches. Exemplary dimensions for the top surface 1510 include a length of 24-60 inches and may be consistent with a length of the front surface 1501) and a width of 1-6 inches. Exemplary dimensions for the notch 1515 include a width of 0.5-4 inches and a length of 1-6 inches. In some instances, the top surface 1510 may be oriented at an angle of greater than 90° relative to the front surface 1505.

As shown in FIG. 15C, a back surface of ball return device body 1500 may include an upper beam 1525 and a lower beam 1530 with an open space 1520 therebetween. As shown in FIG. 15C, an upper edge of upper beam 1525 is coincident with top surface 1510 and a lower edge of lower beam 1530 is coincident with a lower edge of front surface 1505 but, this need not necessarily be the case as upper beam 1525 and/or lower beam 1530 may be offset from the top surface 1510 and/or lower edge, respectively.

Upper beam 1525 and lower beam 1530 may run the entire length of the back surface of ball return device body 1500 and/or a portion or portions thereof. In many instances, upper beam 1525 and lower beam 1530 are parallel to one another but this need not be the case. In many instances, upper beam 1525 may be larger, and extend further away from front surface 1505, than lower beam 1530. In this way, upper beam 1525 supports the positioning of front surface 1505 at an angle of less than 90° relative to the ground, or an underlying surface, upon which ball return device body 1500 rests. Upper beam 1525 also acts to maintain the position of front surface 1505 at the angle of less than 90° relative to the ground when front surface is impacted with another object (e.g., a ball).

Exemplary widths for upper beam 1525 include, but are not limited to, 1-6 inches and heights of 2-7 inches. In some embodiments, a top edge of upper beam 1525 may be positioned at an angle of greater than 90° relative to the front surface 1505 (e.g., 110°-150°). Often times a lower edge of upper beam 1525 may be parallel to the top edge of upper beam 1525 but this not necessarily be the case. A side edge of upper beam 1525 may be positioned at an angle of, for example, 5-40° relative to the front surface 1505.

FIG. 15D provides a side view of upper beam 1525 in which a first edge 1550 is configured to be attached to the back of front surface 1505 and is an approximate length of 1-5 inches. A second edge 1555 is positioned an angle of approximately 50°-75° relative to first edge 1550 and is an approximate length of 1.5 to 5 inches. A third edge 1560 connects to second edge 1555 in a manner that is parallel with first edge first edge 1550 and is an approximate length of 0.5 to 3 inches. A fourth edge 1565 is positioned at a right angle relative to third edge 1560 and has an approximate length of 0.5-2 inches. A fifth edge 1570 extends between fourth edge 1565 and first edge 1550 and has an approximate length of 1-4 inches. In some embodiments, fifth edge 1570 may be parallel to second edge 1555.

FIG. 15E provides a side view of lower beam 1530 in which a first edge 1580 is configured to be attached to the back of front surface 1505 and is an approximate length of 1-5 inches. A second edge 1585 is positioned an angle of approximately 105°-145° relative to first edge 1580 and is an approximate length of 1.5 to 5 inches. A third edge 1590 connects to second edge 1585 at an angle of approximately 35°-65° relative to second edge 1585 and is an approximate length of 0.3 to 2 inches. A fourth edge 1595 is positioned at angle of approximately 105°-145° relative to first edge 1580 and is an approximate length of 0.1 to 1.3 inches. In some embodiments, fourth edge 1595 is approximately parallel to second edge 1585.

FIG. 15F provides an exploded view of ball return device body 1500 in which a relative arrangement of ball return device body 1500 components that includes strike board 1507 with front surface 1505, a portion of top surface 1510, and a portion of two notches 1515. FIG. 15F also shows upper beam 1525, which includes a portion of top surface 1510 and a portion of two notches 1515. FIG. 15F further shows lower beam 1530, two ratchets 1535, and a handle 1540.

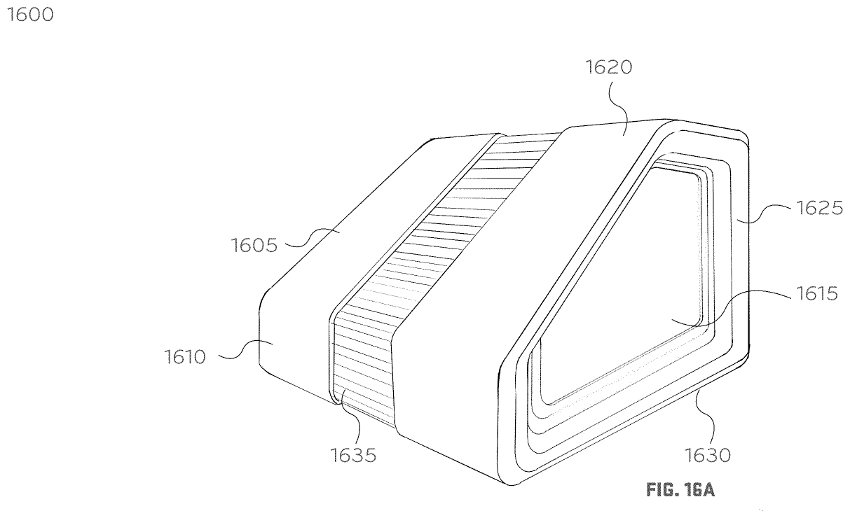

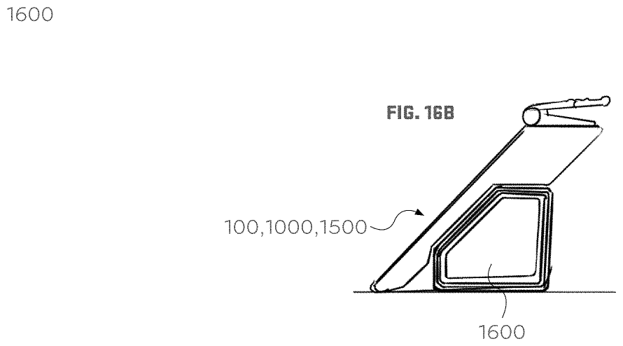

FIG. 16A-19B provide illustrations of various support mechanisms 1600, 1700, 1800, and 1900, respectively adapted to support the ball return device bodies disclosed herein at a preferred angle relative to the ground and/or a surface upon which the ball return device body rests. More specifically, FIG. 16A provides a side perspective view of a support mechanism 1600 and FIG. 16B provides a side view of support mechanism 1600 with a ball return device body, such as ball return device bodies 100, 1000, and/or 1500 positioned thereon. Support mechanism 1600 includes base edge 1630 which, in some embodiments, is adapted to be placed on the ground and/or a support surface upon which a ball return device body will rest and a top edge 1620, which is substantially parallel to base edge 1630. A first side of top edge 1620 is connected to a first side of an angled edge 1605 at a relative angle of approximately −45°. A second side of angled surface 1605 is connected to vertical edge 1610, which is connected to a first side of base edge 1630. A second side of top edge 1620 is connected to a first side of a back edge 1625 at a relative angle of approximately 90°. A second side of back edge 1625 is connected to a second side of base edge 1630. In some embodiments, support mechanism 1600 may also include an opening 1615, or pass through.

The dimensions of support mechanism 1600 may be configured so as to fit within/work with a ball return device body, such as ball return device bodies 100, 1000, and/or 1500 as shown in FIG. 16B where angled edge 1605 and top edge 1620 coincide with cutaway 1020 and/or open space 1520. In some embodiments, a ball return device body may be attached to support mechanism 1600 via a strap positioned within a groove 1635. In some embodiments, two or more support mechanisms 1600 may be used to support a ball return device body and, in other embodiments, support mechanism 1600 may be configured to extend the approximate length of a ball return device body so that only one support mechanism 1600 is needed.

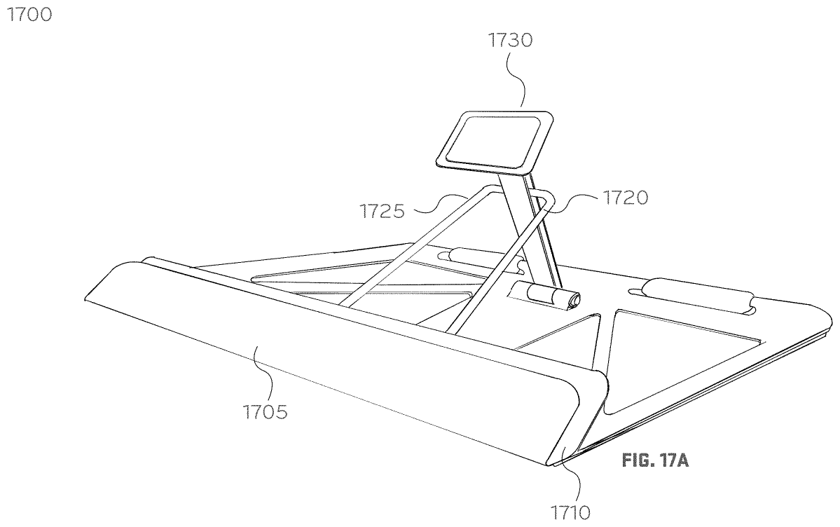

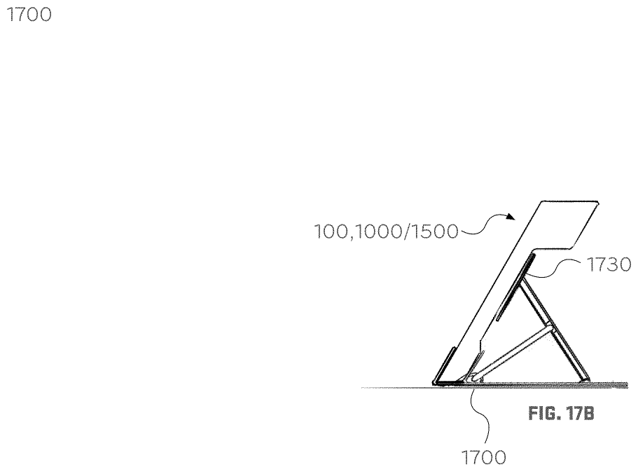

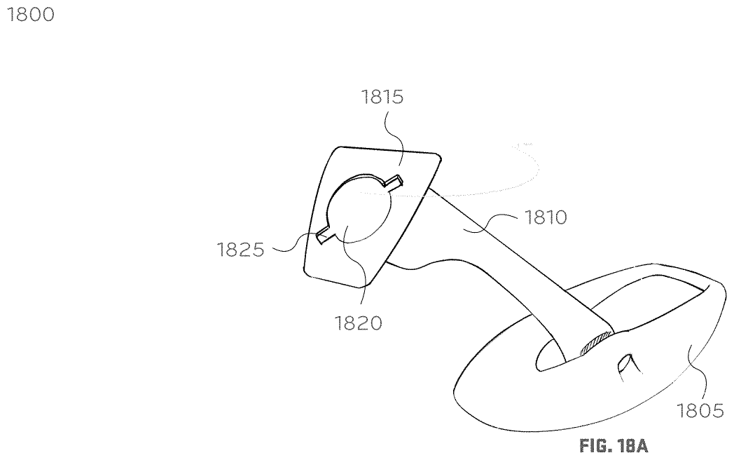

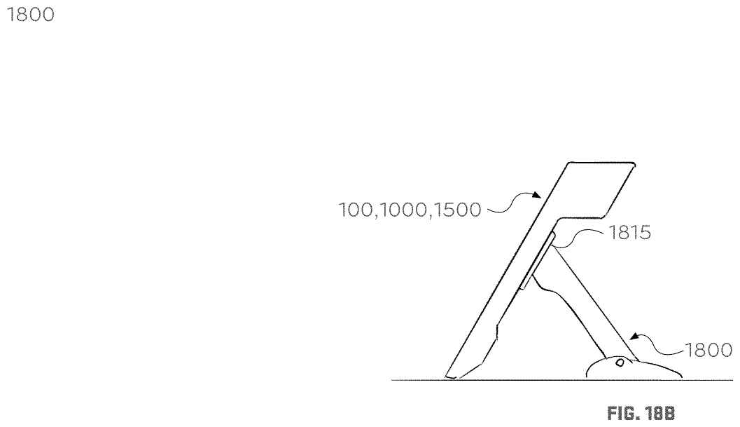

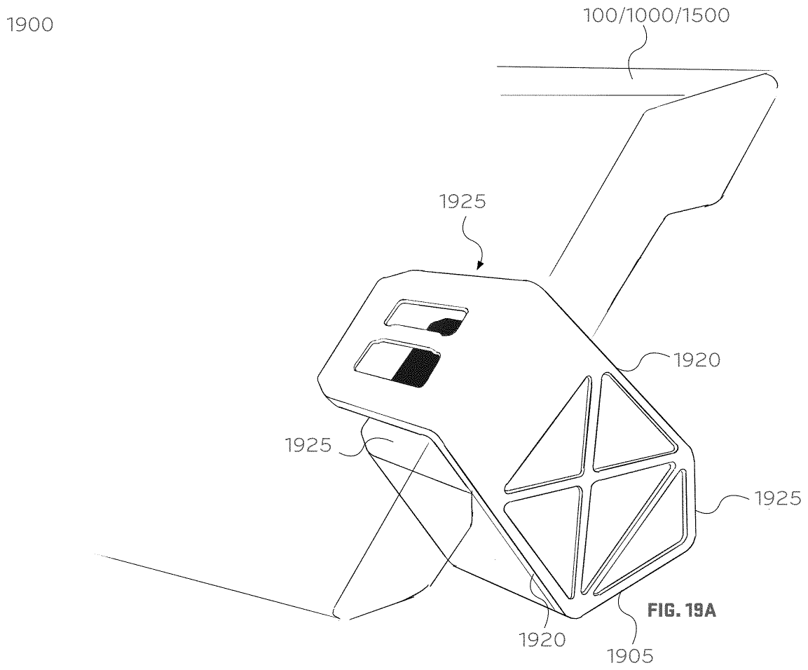

FIG. 17A shows an alternative support mechanism 1700 with a base 1715 configured to rest on the ground and/or a support surface, a lower groove into which a ball return device body may be placed defined by two extensions 1705 of base 1715 an empty channel 1710 therebetween, a support beam 1720, a support arm 1725, and a support pad 1730. Support mechanism 1700 may be designed so that support beam 1720 is collapsible about a hinge and is held in place by support arm 1725.

The dimensions of support mechanism 1700 (e.g., size and position of support pad 1730 when support beam 1720 is extended) may be configured so as to fit within/work with a ball return device body, such as ball return device bodies 100, 1000, and/or 1500 as shown in FIG. 17B where support pad 1730 is positioned within cutaway 1020 and/or open space 1520. In some embodiments, a ball return device body may be attached to support mechanism 1700 via inserting a lower edge of ball return device body into groove 1710 where it may be held in place by extensions 1720. In some embodiments, two or more support mechanisms 1700 may be used to support a ball return device body and, in other embodiments, support mechanism 1700 may be configured to extend the approximate length of a ball return device body so that only one support mechanism 1700 is needed.

FIG. 18A shows an alternative support mechanism 1800 with a base 1805 configured to rest on the ground and/or a support surface the ground and/or a support surface, a support beam 1810, a support pad 1815, a twist lock device 1820, and tabs 1025. Support mechanism 1800 may be designed so that support beam 1820 is collapsible about a hinge. Twist lock device 1820 may engage with a mechanism on the back of a ball return device body, such as ball return device bodies 100, 1000, and/or 1500 and lock in place via, for example, tabs 1825.

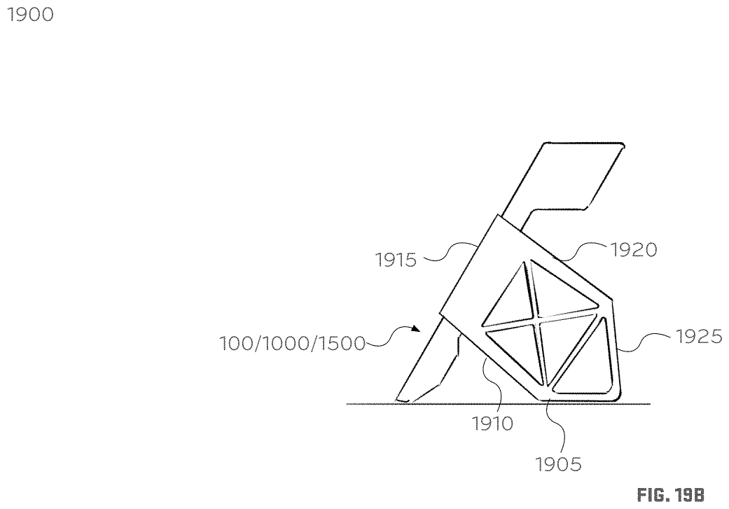

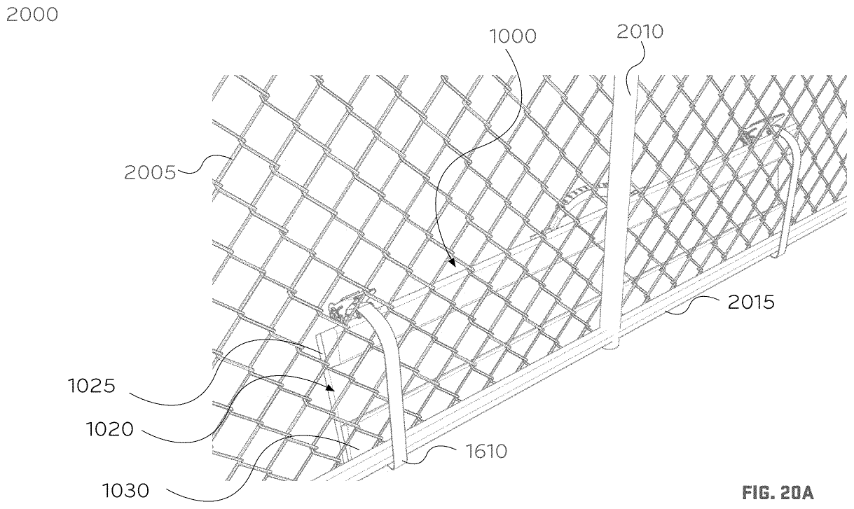

FIG. 19A shows an alternative support mechanism 1900 with a base 1905 configured to rest on the ground and/or a support surface, a groove 1925 into which a ball return device body may be placed, which is defined by an extensions 1915 and a portion of base 1905. Support mechanism 1900 is also defined by a first edge 1910 extends from a first side of base 1905 at an angle of approximately 135° and a second edge 1920 that is substantially parallel with first edge 1910. Support mechanism 1900 may be designed so that a side of a ball return device body is placed with groove 1925 and, in some embodiments, the ball return device body may be held within groove 1925 via a ratchet webbing pass through 1930 that includes two holes through with webbing (or a strap) may pass to be eventually coupled to a ratchet and thereby secured to support mechanism 1900.

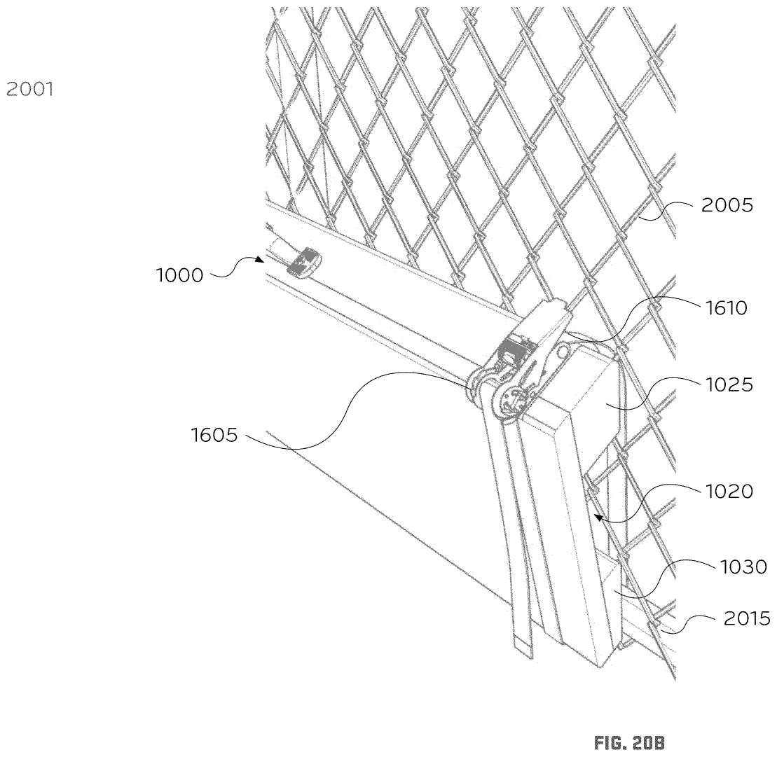

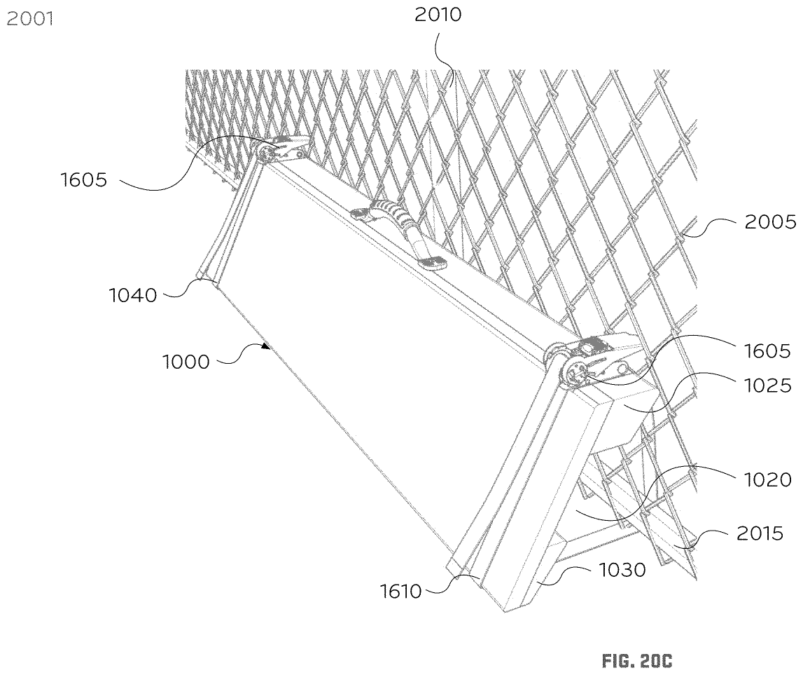

FIGS. 20A-20C provide images of exemplary ball return device body 1000 when attached to an external anchoring mechanism in the form of a chain-link fence 1205. Although the images of FIGS. 20A-20C show how ball return device body 1000 is attached to the external anchoring mechanism, is will be understood by those of skill in the art that attachment of ball return device body 100 and/or 1500 may be made using similar external anchoring mechanisms, attachment mechanisms, and techniques.

FIG. 20A shows an arrangement 2000 of ball return device body 1000 when placed with a lower edge coincident with a grass playing field and lower beam 1030 is positioned up against a lower portion of chain-link fence 1205 coincident with a base pole 2015 of the chain-link fence 1205. As pictured, the portion of chain-link fence 1205 pictured in FIG. 20A includes a fence post 2010 but, ball return device body 1000 need not be attached to a fence, or fence portion, that includes a fence post.

In order to affix ball return device body 1000 to chain-link fence 1205, strap 1415 is passed under base pole 2015 and through one of the openings in chain-link fence 1205 so as to be fed through ratchet 1405. Once strap 1415 is tightened within ratchet 1405, ball return device body may be positioned so as to coincide with the plane of chain-link fence 1205 so that upper beam 1025 and lower beam 1030 is substantially coincident with chain-link fence 1205 as shown in the arrangement 2001 of FIG. 20B. Due to the relative sizes and dimensions of upper beam 1025 and lower beam 1030, the front surface of ball return device body 1000 is oriented at an angle of less than 90° relative to the grass field.

FIG. 20C shows an alternate arrangement 2002 for ball return device body 1000 relative to the grass field. In this alternate arrangement, the lower edge of ball return device body is not coincident with base pole 2015 but, instead, is approximately 8 inches away from base pole 2015 and an upper edge of upper beam 1025 is touching chain-link fence 1205. In this way, the back surface of ball return device body 100, the ground, and the chain-link fence 1205 form a triangle-like shape. When oriented in this fashion, a ball incident on ball return device body 1000 may be returned at with an upward trajectory (i.e., not along the ground) to the player so that, for example, the player may practice receiving balls that are off the ground (i.e., pop-ups). The ball return device body may be maintained in arrangement 2002 via cooperation between the strap 1415, ratchet, and friction provided by the ground and/or chain-link fence 1205.

For some of the embodiments described above the upper and/or lower beams of a ball return device body described herein may be adjustable. For example, upper beam 1025, upper beam 1525, lower beam 1030, and/or lower beam 1530 may be collapsible (e.g., fold down from an extended position via, for example, a hinge) and/or may be removable for storage and/or transport. In some instances, a size and/or orientation of upper beam 1025, upper beam 1525, lower beam 1030, and/or lower beam 1530 may be adjustable by, for example, adding and/or subtracting components from upper and/or lower beams.

Additionally, or alternatively, some of the embodiments described above the upper and/or lower beams of a ball return device body described herein may be configured to position the front surface at a desired angle relative to the ground when positioned against a vertical surface (e.g., fence or wall). For example, upper beam 1025, upper beam 1525, lower beam 1030, and/or lower beam 1530 may be collapsible (e.g., fold down from an extended position via, for example, a hinge) and/or may be removable for storage and/or transport. In some instances, a size and/or orientation of upper beam 1025, upper beam 1525, lower beam 1030, and/or lower beam 1530 may be adjustable by, for example, adding and/or subtracting components from upper and/or lower beams.

In some circumstances, ball return device bodies 1000 and/or 1500 may not have upper beam 1025, upper beam 1525, lower beam 1030, and/or lower beam 1530, respectively and a back surface of ball return device bodies 1000 and/or 1500 may be single planar surface (e.g., without cutaway or carve out 1020 and/or open space 1520) so that a cross section of ball return device bodies 1000 and/or 1500 may be a polygon similar to, for example, ball return device body 100.

Additionally, or alternatively, ball return device bodies 1000 and/or 1500 may not have upper beam 1025, upper beam 1525, lower beam 1030, and/or lower beam 1530, respectively and a back surface of ball return device bodies 1000 and/or 1500 may include one or more vertically oriented beams that are, for example, wider on one side (i.e., a side coincident with top side 1010 or top 1510, respectively) than on another side (i.e., a side coincident with top side 1010 or top side 1510, respectively) in a triangular- and/or polygonal-type of shape.

In some embodiments, ball return device bodies 100, 1000 and/or 1500 may be hollow or partially hollow. In some instances, an exterior surface of ball return device bodies 100, 1000, and/or 1500 may be made from one material (e.g., a dense plastic) and an interior of ball return device bodies 100, 1000 and/or 1500 may be hollow so as to accept a filler material (e.g., sand or water) inserted after receipt by a customer and/or at a location of intended use of the respective ball return device body. Additionally, or alternatively, an exterior surface of ball return device bodies 100, 1000, and/or 1500 may be made from one material (e.g., a dense plastic) and an interior of ball return device bodies 100, 1000 and/or 1500 may be made from a less-dense material (e.g., foam).

In some embodiments, a plurality of ball return device bodies 100, 1000, and/or 1500 may be joined together along a length of, for example, a fence or playing surface perimeter so as to, for example, mark off the boundaries for a play area and/or provide a continuous surface against which multiple players may practice ball skills. The plurality of ball return devices may be joined together via one or more joining mechanisms (e.g., straps, hooks, bungee cords, etc.). In some embodiments, a single and/or plurality of ball return devices may serve as a location on which to display signs, advertisements or other messages as may be provided by decals, stickers, banners, and so on.

In some instances, ball return device bodies 100, 1000, and/or 1500 may be permanently attached to an anchoring mechanism via, or example, heavy-duty hardware (e.g., screws, clamps, etc.) and/or a bonding agent (e.g., glue, epoxy, etc.). For example, a ball return device body 100, 1000, and/or 1500 may be screwed into a fence post or fence posts and/or one or more clamps may be screwed into a ball return device body 100, 1000, and/or 1500.

In some circumstances, ball return device bodies 100, 1000, and/or 1500 may be adapted for use indoors (e.g., in a basement and/or garage or a residence) and one or more dimensions of ball return device bodies 100, 1000, and/or 1500 and/or support mechanisms may be adapted for use in this environment. For example, a length of ball return device bodies 100, 1000, and/or 1500 may be reduced to, for example, 2 or 3 feet so that it may be easily installed indoors. In some instances, a ball return device body 100, 1000, and/or 1500 may be adapted for installation in a doorjamb. In these instances, a support mechanism (e.g., support mechanism 1900) may be adapted for installation in a doorjamb or on the walls of a hallway so that a ball return device body 100, 1000, and/or 1500 may be removably inserted into the support mechanism when in use and removed from the support mechanism when not in use thereby allowing typical use of the doorjamb as a passageway.

Some combinations of ball return device bodies 100, 1000, and/or 1500 and a support mechanism and/or attachment mechanism may include a vibration- and/or sound-dampening feature adapted to reduce vibration/sound produced by a ball impacting the ball return device body 100, 1000, and/or 1500. Exemplary vibration- and/or sound-dampening features include foam inserts or a foam or cushioned backdrop adapted for installation on a portion of a back surface of vibration- and/or sound-dampening feature and/or on an upper and/or lower beam of ball return device body 1000 and/or 1500. This vibration- and/or sound-dampening feature may be of particular importance when ball return device body 100, 1000, and/or 1500 is used inside, particularly when ball return device body 100, 1000, and/or 1500 is attached to a external anchor with good sound reverberation properties (e.g., a metal garage door).

I claim:

1. A ball return device comprising:
a body having a flat and contiguous front surface configured to return a soccer ball incident thereon, a top, a bottom, a first side edge, a second side edge, and a back surface, a first beam projecting a first distance from the back surface, the first beam extending along a length the back surface parallel and proximate to the top and a second beam extending along a length of the back surface, proximate to the bottom, in a direction parallel to the first beam, the second beam projecting a second distance from the back surface, the second distance being smaller than the first distance.

2. The ball return device of claim 1, wherein a relative relationship between the first distance of the first beam and the second distance of the second beam orients the front surface at an angle of less than 90° relative to the underlying surface when the first beam and the second beam are positioned against a vertical anchoring mechanism oriented at an angle of almost 90° relative to an underlying surface.

3. The ball return device of claim 1, wherein a relative relationship between the first distance of the first beam and the second distance of the second beam orients the front surface at an angle of greater than 90° relative to the underlying surface when the first beam and the second beam are positioned against a vertical anchoring mechanism oriented at an angle of almost 90° relative to an underlying surface.

4. The ball return device of claim 1, wherein an exterior surface of the first beam furthest away from the front surface is oriented at an angle that is not parallel to the front surface.

5. The ball return device of claim 1, further comprising:
an attachment mechanism that is a combination of a strap and a ratchet.

6. The ball return device of claim 1, wherein the ball return device has a first attachment mechanism positioned at a first end of the body and a second attachment mechanism positioned at a second end of the body.

7. The ball return device of claim 1, further comprising a handle.

8. The ball return device of claim 1, wherein an angle between a ground surface and the front surface is variable.

9. The ball return device of claim 1, further comprising:
a support device joining mechanism configured to join with an external support device, the external support device being adapted to maintain an orientation of the body once the body is positioned thereon.

10. The ball return device of claim 1, wherein the body includes a joining mechanism configured to enable the ball return device to be joined with another ball return device.

11. The ball return device of claim 1, further comprising:
an attachment mechanism configured to attach the body to an external anchoring mechanism that is a chain-link fence, wherein a portion of the attachment mechanism is configured to pass through one or more of chain links of the chain-link fence.

12. The ball return device of claim 1, further comprising:
an attachment mechanism configured to attach the body to an external anchoring mechanism that is a post, wherein a portion of the attachment mechanism is configured to wrap partially around the post.

13. The ball return device of claim 1, wherein an angle between a ground surface and the front surface is set so that the front surface rebounds a ball incident on the front surface with a spin that mimics a ball spin of an incoming pass.

14. The ball return device of claim 1, wherein the bottom of the body is configured to abut an underlying surface that is a grass field.

15. The ball return device of claim 1, further comprising:
an attachment mechanism configured to attach the body to a garage door.

16. The ball return device of claim 1, further comprising:
an attachment mechanism configured to attach the body to a doorjamb.

17. A ball return device comprising:
a body having a flat and contiguous front surface configured to return a soccer ball incident thereon, a top, a bottom, a first side edge, a second side edge, and a back surface, a first beam projecting a first distance from the back surface, the first beam extending along a length the back surface parallel and proximate to the top and a second beam extending along a length of the back surface, proximate to the bottom, in a direction parallel to the first beam, the second beam projecting a second distance from the back surface, the second distance being smaller than the first distance, the body being configured to abut an external anchoring mechanism when attached to the external anchoring mechanism via an attachment mechanism configured to attach the body to an external anchoring mechanism so that the portion of the back surface configured to abut an external anchoring mechanism abuts the external anchoring mechanism; and
the attachment mechanism coupled to the body and configured to attach the body to the external anchoring mechanism so that a portion of at least one of the first beam and the second bean about the external anchoring mechanism, wherein the external anchoring mechanism is not a ground surface.

18. The ball return device of claim 17, wherein the attachment mechanism is a combination of a strap and a ratchet.

19. The ball return device of claim 17, wherein external anchoring mechanism is a chain-link fence and a portion of the attachment mechanism is configured to pass through one or more of chain links of the chain-link fence.

20. A ball return device comprising:
a body having a flat and contiguous front surface configured to return a ball incident thereon, a back, a top, a bottom, a first side edge, and a second side edge, a first beam projecting a first distance from a the back surface parallel and proximate to the top and a second beam extending along a length of the back surface, proximate to the bottom, in a direction parallel to the first beam, the second beam projecting a second distance from the back surface, the second distance being smaller than the first distance, the body being configured to be positioned at an angle to, and coincident with, an underlying ground surface so that at least one of the top and the bottom are coincident with the underlying ground surface, the body being further configured to cooperate with an attachment mechanism configured to attach the body to an external anchoring mechanism so that a portion of the body abuts the external anchoring mechanism.

21. The ball return device of claim 20, wherein the attachment mechanism is a combination of a strap and a ratchet.

22. The ball return device of claim 20, wherein the external anchoring mechanism is a chain-link fence and a portion of the attachment mechanism is configured to pass through one or more of chain links of the chain-link fence.

23. The ball return device of claim 1, wherein a length that at least one of the first beam and the second beam extends along the back surface is from the first side edge to the second side edge.

24. The ball return device of claim 17, wherein a length that at least one of the first beam and the second beam extends along the back surface is from the first side edge to the second side edge.

25. The ball return device of claim 20, wherein a length that at least one of the first beam and the second beam extends along the back surface is from the first side edge to the second side edge.
